(19) United States
(12) Patent Application Publication
(10) Pub. No.: US 2023/0369643 A1
(43) Pub. Date: Nov. 16, 2023

(54) Rechargeable Sodium Battery Containing a Solid Elastomer Electrolyte and Manufacturing Method

(71) Applicant: Global Graphene Group, Inc., Dayton, OH (US)

(72) Inventor: Bor Z. Jang, Centerville, OH (US)

(73) Assignee: Global Graphene Group, Inc., Dayton, OH (US)

(21) Appl. No.: 17/662,724

(22) Filed: May 10, 2022

(51) Int. Cl. H01M 10/0565; H01M 10/054; H01M 50/411; H01M 50/489

(52) U.S. Cl. CPC H01M 10/0565; H01M 10/054; H01M 50/411; H01M 50/489; H01M 2300/0082

(57) ABSTRACT

A rechargeable sodium cell, comprising an anode, a cathode, an elastic polymer separator disposed between the cathode and the anode, wherein the elastic polymer separator has a thickness from 10 nm to 200 μm (preferably less than 50 μm) and comprises a high-elasticity polymer having a sodium ion conductivity from 10⁻⁸ S/cm to 5×10⁻² S/cm at room temperature and a fully recoverable tensile strain from 2% to 1,000% when measured without any additive dispersed therein. The cell can be a sodium metal cell, sodium-air cell, sodium-ion cell, sodium-sulfur cell, or a sodium-selenium cell.

### FIELD

The present disclosure is directed at the electrolyte, separator or sodium metal protecting layer of a sodium ion or sodium metal battery.

### BACKGROUND

Rechargeable lithium-ion (Li-ion) and lithium metal batteries (including Li-sulfur and Li metal-air batteries) are considered promising power sources for electric vehicle (EV), hybrid electric vehicle (HEV), and portable electronic devices, such as lap-top computers and mobile phones. Lithium as a metal element has the highest capacity (3,861 mAh/g) compared to any other metal or metal-intercalated compound as an anode active material (except Li_{4.4}Si, which has a specific capacity of 4,200 mAh/g). Hence, in general, Li metal batteries have a significantly higher energy density than lithium-ion batteries. However, lithium is not an abundant element in the earth's crust and lithium is only mined in a very limited number of countries. There is fear for short supply of lithium as the EV industry is rapidly emerging and, hence, the demand for lithium batteries can outpace the supply of lithium.

As a totally distinct class of energy storage device, sodium (Na) batteries have been considered an attractive alternative to lithium batteries since sodium is abundant and the production of sodium is significantly more environmentally benign compared to the production of lithium. In addition, the high cost of lithium is a major issue and Na batteries potentially can be of significantly lower cost.

There are at least two types of sodium batteries that operate on bouncing sodium ions (Na⁺) back and forth between an anode and a cathode: the sodium metal battery having Na metal or alloy as the anode active material and the sodium-ion battery having a Na intercalation compound as the anode active material. Sodium ion batteries using a hard carbon-based anode active material (a Na intercalation compound) and a sodium transition metal phosphate as a cathode have been described by several research groups; e.g., J. Barker, et al. “Sodium Ion Batteries,” U.S. Pat. No. 7,759,008 (Jul. 20, 2010).

Instead of hard carbon or other carbonaceous intercalation compound, sodium metal may be used as the anode active material in a sodium metal cell. However, the use of metallic sodium as the anode active material is conventionally considered undesirable and dangerous due to the dendrite formation, interface aging, and electrolyte incompatibility problems.

Despite some earlier efforts to address these issues, no rechargeable Na metal batteries have yet succeeded in the marketplace. This is likely due to the notion that these prior art approaches still have major deficiencies. For instance, in several cases, the anode or electrolyte structures are too complex. In others, the materials are too costly or the processes for making these materials are too laborious or difficult. Solid electrolytes typically have a low sodium ion conductivity, are difficult to produce and difficult to implement into a battery.

Furthermore, solid electrolyte, as the sole electrolyte in a cell or as an anode-protecting layer (interposed between the sodium film and the liquid electrolyte) does not have and cannot maintain a good contact with the sodium metal. This effectively reduces the effectiveness of the electrolyte to support dissolution of sodium ions (during battery discharge), transport sodium ions, and allowing the sodium ions to re-deposit back to the anode (during battery recharge).

Another major issue associated with the sodium metal anode is the continuing reactions between electrolyte and sodium metal, leading to repeated formation of “dead sodium-containing species” that cannot be re-deposited back to the anode and become isolated from the anode. These reactions continue to irreversibly consume electrolyte and sodium, resulting in rapid capacity decay. In order to compensate for this continuing loss of sodium metal, an excessive amount of sodium metal (3-5 times higher amount than what would be required) is typically implemented at the anode when the battery is made. This adds not only costs but also a significant weight and volume to a battery, reducing the energy density of the battery cell. This important issue has been largely ignored and there has been no plausible solution to this problem in battery industry.

Clearly, an urgent need exists for a simpler, more cost-effective, and easier to implement approach to preventing Na metal dendrite-induced internal short circuit and thermal runaway problems in Na metal batteries, and to reducing or eliminating the detrimental reactions between sodium metal and the electrolyte.

Hence, an object of the present disclosure is to provide an effective way to overcome the sodium metal dendrite and reaction problems in all types of Na batteries having a sodium metal anode. A specific object of the present disclosure is to provide a sodium metal cell or sodium-ion cell that exhibits a high specific capacity, high specific energy, high degree of safety, and a long and stable cycle life.

### SUMMARY

The present disclosure provides a rechargeable sodium cell, comprising an anode, a cathode, and an elastic polymer separator disposed between the cathode and the anode, wherein the elastic polymer separator has a thickness from 10 nm to 100 μm and comprises a high-elasticity polymer having a sodium ion conductivity from 10⁻⁸ S/cm to 5×10⁻² S/cm at room temperature and a fully recoverable tensile strain from 2% to 1,000% when measured without any additive dispersed therein. The cell can be a sodium metal cell, sodium-ion cell, or sodium-sulfur cell

In certain embodiments, the rechargeable sodium cell is a sodium metal cell wherein the anode has an anode current collector but initially the anode has no sodium or sodium alloy as an anode active material supported by the anode current collector when the battery cell is made and prior to a charge or discharge operation of the battery. The sodium ions are initially stored in the cathode, as part of a cathode active material.

In certain embodiments, the rechargeable sodium cell is a sodium metal cell wherein the anode has an anode current collector and an amount of sodium or sodium alloy (e.g., in the form of powder, coating, or thin film) as an anode active material supported by the anode current collector.

In some embodiments, the rechargeable sodium cell is a sodium-ion cell wherein the anode active material contains a sodium intercalation compound.

In the rechargeable sodium cell, the high-elasticity polymer may comprise an elastomer or rubber selected from natural polyisoprene, synthetic polyisoprene, polybutadiene, chloroprene rubber, polychloroprene, butyl rubber, butyl acrylic rubber, poly(butyl diacrylate), styrene-butadiene rubber, nitrile rubber, ethylene propylene rubber, ethylene propylene diene rubber, metallocene-based poly(ethylene-co-octene) elastomer, poly(ethylene-co-butene) elastomer, styrene-ethylene-butadiene-styrene elastomer, epichlorohydrin rubber, polyacrylic rubber, silicone rubber, fluorosilicone rubber, perfluoroelastomers, polyether block amides, chlorosulfonated polyethylene, ethylene-vinyl acetate, thermoplastic elastomer, protein resilin, protein elastin, ethylene oxide-epichlorohydrin copolymer, polysiloxane, poly(alkyl siloxane), polyurethane, urethane-urea copolymer, urethane-acrylic copolymer, a copolymer thereof, a sulfonated version thereof, or a combination thereof.

In some embodiments, the high-elasticity polymer contains a lightly cross-linked network of polymer chains having an ether linkage, nitrile-derived linkage, benzo peroxide-derived linkage, ethylene oxide or ethylene glycol linkage, propylene oxide linkage, vinyl alcohol linkage, cyano-resin linkage, triacrylate monomer-derived linkage, tetraacrylate monomer-derived linkage, a derivative thereof, or a combination thereof, and the cross-linked network of polymer chains has a degree of crosslinking that affords an elasticity of the polymer in the range from 5% to 1,000%.

The elastic polymer separator may further comprise from 0.1% to 70% by weight of a sodium ion-conducting material dispersed or dissolved in the high-elasticity polymer. Such a sodium ion-conducting material may be selected from a sodium salt, an inorganic solid electrolyte material (e.g., Nasicon, beta-alumina, sulfide-type, complex hydride-type, etc.), and/or an organic (polymeric) electrolyte.

In certain embodiments, the sodium ion-conducting material comprises a sodium salt selected from sodium perchlorate (NaClO₄), sodium chlorate (NaClO₃), sodium hexafluorophosphate (NaPF₆), sodium borofluoride (NaBF₄), sodium hexafluoroarsenide, sodium trifluoro-metasulfonate (NaCF₃SO₃), bis-trifluoromethyl sulfonylimide sodium (NaN(CF₃SO₂)₂), sodium trifluoromethanesulfonimide (NaTFSI), sodium bis(fluoroallyl)malonato borate salt (NaBFMB), sodium poly(tartaric acid)borate (NaPTAB) salt, NaCF₃COO, Na₂CO₃, Na₂O, Na₂C₂O₄, NaOH, NaX, ROCO₂Na, HCONa, RONa, (ROCO₂Na)₂, (CH₂OCO₂Na)₂, Na₂S, NaₓSO_{y}, wherein X═F, Cl, I, or Br, R=a hydrocarbon group, x=0-1, y=1-4, or a combination thereof.

The sodium ion-conducting material may comprise an inorganic solid electrolyte material having a sodium ion conductivity no less than 10⁻⁸ S/cm, preferably no less than 10⁻⁶ S/cm, more preferably no less than 10⁻⁴ S/cm, and most preferably no less than 10⁻³ S/cm. Complex hydride type solid-state electrolytes can have a sodium ion conductivity greater than 10⁻² S/cm.

The high-elasticity polymer may form a mixture, blend, copolymer, crosslinked network, or interpenetrating network with a sodium ion-conducting polymer selected from poly(ethylene oxide) (PEO), Polypropylene oxide (PPO), polyethylene glycol (PEG), polyvinyl alcohol (PVA), poly(vinyl pyrrolidone) (PVP), poly(ethyl methacrylate) (PEMA), poly(acrylonitrile) (PAN), poly(methyl methacrylate) (PMMA), poly(vinylidene fluoride) (PVdF), Poly bis-methoxy ethoxyethoxide-phosphazenex, Polyvinyl chloride, Polydimethylsiloxane, poly(vinylidene fluoride)-hexafluoropropylene (PVDF-HFP), a sulfonated derivative thereof, or a combination thereof.

In some preferred embodiments, the high-elasticity polymer comprises from 5% to 95% by weight of a lithium ion-conducting plastic crystal or plasticizer dispersed in or connected to the high-elasticity polymer. Preferably, the high-elasticity polymer and the plastic crystal or organic plasticizer form co-continuous phases exhibiting a sodium-ion conductivity no less than 10⁻⁵ S/cm, preferably higher than 10⁻³ S/cm.

The plastic crystal or organic plasticizer may comprise a mixture of a sodium salt and a sodium ion-conducting organic species selected from a fluorinated carbonate, hydrofluoroether, fluorinated vinyl carbonate, fluorinated ester, fluorinated vinyl ester, fluorinated vinyl ether, sulfone, sulfide, nitrile, phosphate, phosphite, phosphonate, sulfate, siloxane, silane, 1,3-dioxolane (DOL), 1,2-dimethoxyethane (DME), tetraethylene glycol dimethylether (TEGDME), poly(ethylene glycol) dimethyl ether (PEGDME), diethylene glycol dibutyl ether (DEGDBE), 2-ethoxyethyl ether (EEE), sulfolane, acetonitrile (AN), acrylonitrile, succinonitrile, fluoroethylene carbonate (FEC), an ionic liquid solvent, a polymerized version thereof, or a combination thereof.

In some embodiments, the rechargeable sodium cell is a sodium-ion cell wherein the anode active material contains an alkali intercalation compound selected from meso-phase pitch, meso-phase carbon, meso carbon micro-beads (MCMB), coke particles (e.g., needle coke), expanded graphite flakes, artificial graphite particles, natural graphite particles, highly oriented pyrolytic graphite, soft carbon particles, hard carbon particles, multi-walled carbon nanotubes, carbon nano-fibers, carbon fibers, graphite nano-fibers, graphite fibers, carbonized polymer fibers, carbon black, amorphous carbon, activated carbon, templated carbon, hollow carbon nanowires, hollow carbon sphere, silicon (Si), phosphorus (P), sodium titanates, NaTi₂(PO₄)₃, Na₂Ti₃O₇, Na₂C₈H₄O₄, Na₂TP, NaₓTiO₂ (x=0.2 to 1.0), disodium terephthalate (Na₂C₈H₄O₄), carboxylate based materials, C₈H₄Na₂O₄, C₈H₆O₄, C₈H₅NaO₄, C₈Na₂F₄O₄, C₁₀H₂Na₄O₈, C₁₄H₄O₆, C₁₄H₄Na₄O₈, or a combination thereof.

The alkali intercalation compound or alkali-containing compound as an anode active material may be selected from the following groups of materials: (a) Sodium- or potassium-doped silicon (Si), germanium (Ge), tin (Sn), lead (Pb), antimony (Sb), bismuth (Bi), zinc (Zn), aluminum (Al), titanium (Ti), cobalt (Co), nickel (Ni), manganese (Mn), cadmium (Cd), and mixtures thereof; (b) Sodium- or potassium-containing alloys or intermetallic compounds of Si, Ge, Sn, Pb, Sb, Bi, Zn, Al, Ti, Co, Ni, Mn, Cd, and their mixtures; (c) Sodium- or potassium-containing oxides, carbides, nitrides, sulfides, phosphides, selenides, tellurides, or antimonides of Si, Ge, Sn, Pb, Sb, Bi, Zn, Al, Fe, Ti, Co, Ni, Mn, Cd, and mixtures or composites thereof; (d) Sodium or potassium salts; and (e) Graphene sheets pre-loaded or pre-attached with sodium ions (herein referred to as pre-sodiated graphene sheets).

The carbon or graphite material in the anode may be selected from those having an expanded inter-graphene planar spacing. For instance, meso-phase pitch, meso-phase carbon, meso carbon micro-beads (MCMB), coke particles, expanded graphite flakes, artificial graphite particles, natural graphite particles, highly oriented pyrolytic graphite, soft carbon particles, hard carbon particles, multi-walled carbon nanotubes, carbon nano-fibers, carbon fibers, graphite nano-fibers, graphite fibers, carbonized polymer fibers, or a combination thereof, wherein the carbon or graphite material has an inter-planar spacing d₀₀₂ from 0.27 nm to 0.42 nm prior to a chemical or physical expansion treatment and the inter-planar spacing d₀₀₂ is increased to from 0.43 nm to 3.0 nm after the expansion treatment.

In certain embodiments, the carbon or graphite material is selected from graphite foam or graphene foam having pores and pore walls, wherein the pore walls contain a stack of bonded graphene planes having an expanded inter-planar spacing d₀₀₂ from 0.45 nm to 1.5 nm. Preferably, the stack contains from 2 to 100 graphene planes.

In the disclosed rechargeable sodium-ion cell, the inter-planar spacing d₀₀₂ may be from 0.5 nm to 1.2 nm. Preferably, the inter-planar spacing d₀₀₂ is from 1.2 nm to 2.0 nm.

In some preferred embodiments, the expansion treatment may include an oxidation, fluorination, bromination, chlorination, nitrogenation, intercalation, combined oxidation-intercalation, combined fluorination-intercalation, combined bromination-intercalation, combined chlorination-intercalation, or combined nitrogenation-intercalation of the graphite or carbon material. These expansion treatments may be further followed by a constrained thermal expansion treatment to increase the d spacing from a more typical range of 0.5-1.2 nm to a range of 1.2-3.0 nm.

The carbon or graphite material may contain a non-carbon element selected from oxygen, fluorine, chlorine, bromine, iodine, nitrogen, hydrogen, or boron.

The present disclosure also provides an anode for a rechargeable sodium-ion cell, wherein the anode comprises a graphite or carbon material having expanded inter-graphene planar spaces with an inter-planar spacing d₀₀₂ from 0.43 nm to 3.0 nm, as measured by X-ray diffraction, and the expanded inter-graphene planar spaces store sodium ions to a specific capacity no less than 150 mAh/g when the cell is in a charged state.

In certain embodiments, the carbon or graphite material is selected from graphite foam or graphene foam having pores and pore walls, wherein said pore walls contain a stack of bonded graphene planes having an expanded inter-planar spacing d₀₀₂ from 0.45 nm to 1.5 nm. The stack can contain from 2 to 100 graphene planes.

In the rechargeable sodium-ion cell, the working electrolyte may be selected from solid polymer electrolyte, polymer gel electrolyte, composite electrolyte, ionic liquid electrolyte, non-aqueous liquid electrolyte, soft matter phase electrolyte, inorganic solid-state electrolyte, or a combination thereof.

In certain embodiments, the electrolyte contains a salt selected from sodium perchlorate (NaClO₄), potassium perchlorate (KClO₄), sodium hexafluorophosphate (NaPF₆), potassium hexafluorophosphate (KPF₆), sodium borofluoride (NaBF₄), potassium borofluoride (KBF₄), sodium hexafluoroarsenide, potassium hexafluoroarsenide, sodium trifluoro-metasulfonate (NaCF₃SO₃), potassium trifluoro-metasulfonate (KCF₃SO₃), bis-trifluoromethyl sulfonylimide sodium (NaN(CF₃SO₂)₂), sodium trifluoromethanesulfonimide (NaTFSI), bis-trifluoromethyl sulfonylimide potassium (KN(CF₃SO₂)₂), an ionic liquid salt, a combination thereof, or a combination with lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂, Lithium bis(oxalato)borate (LiBOB), lithium oxalyldifluoroborate (LiBF₂C₂O₄), lithium oxalyldifluoroborate (LiBF₂C₂O₄), Lithium nitrate (LiNO₃), Li-Fluoroalkyl-Phosphates (LiPF₃(CF₂CF₃)₃), or lithium bisperfluoroethysulfonylimide (LiBETI).

The solvent in the electrolyte may be selected from ethylene carbonate (EC), dimethyl carbonate (DMC), methylethyl carbonate (MEC), diethyl carbonate (DEC), ethyl propionate, methyl propionate, propylene carbonate (PC), gamma.-butyrolactone (γ-BL), acetonitrile (AN), ethyl acetate (EA), propyl formate (PF), methyl formate (MF), toluene, xylene or methyl acetate (MA), fluoroethylene carbonate (FEC), vinylene carbonate (VC), allyl ethyl carbonate (AEC), 1,3-dioxolane (DOL), 1,2-dimethoxyethane (DME), tetraethylene glycol dimethylether (TEGDME), Poly(ethylene glycol) dimethyl ether (PEGDME), diethylene glycol dibutyl ether (DEGDBE), 2-ethoxyethyl ether (EEE), sulfone, sulfolane, room temperature ionic liquid, or a combination thereof.

There is no particular restriction on the type of cathode active material that can be implemented in the cathode of the presently disclosed sodium-ion cell. In certain embodiments, the cathode comprises a cathode active material selected from NaFePO₄, Na₍₁₋ₓ₎KₓPO₄, KFePO₄, Na_{0.7}FePO₄, Na_{1.5}VOPO₄F_{0.5}, Na₃V₂(PO₄)₃, Na₃V₂(PO₄)₂F₃, Na₂FePO₄F, NaFeF₃, NaVPO₄F, KVPO₄F, Na₃V₂(PO₄)₂F₃, Na_{1.5}VOPO₄F_{0.5}, Na₃V₂(PO₄)₃, NaV₆O₁₅, NaₓVO₂, Na_{0.33}V₂O₅, NaₓCoO₂, Na_{2/3}[Ni_{1/3}Mn_{2/3}]O₂, Naₓ(Fe_{1/2}Mn_{1/2})O₂, NaₓMnO₂, λ-MnO₂, NaₓK₍₁₋ₓ₎MnO₂, Na_{0.44}MnO₂, Na_{0.44}MnO₂/C, Na₄Mn₉O₁₈, NaFe₂Mn(PO₄)₃, Na₂Ti₃O₇, Ni_{1/3}Mn_{1/3}Co_{1/3}O₂, Cu_{0.56}Ni_{0.44}HCF, NiHCF, NaₓMnO₂, NaCrO₂, KCrO₂, Na₃Ti₂(PO₄)₃, NiCo₂O₄, Ni₃S₂/FeS₂, Sb₂O₄, Na₄Fe(CN)₆/C, NaV₁₋ₓCrₓPO₄F, Se_{z}S_{y}, y/z=0.01 to 100, Se, sodium polysulfide, sulfur, Alluaudites, or a combination thereof, wherein x is from 0.1 to 1.0.

In some embodiments, the cathode comprises a cathode active material selected from a Na-based layered oxide (e.g., O3-type, P2-type, or P3-type), a polyanionic compound, a mixed polyanionic compound, a sulfate, a pyrophosphate, a Prussian Blue analog, or a combination thereof. In some specific embodiments, the cathode comprises a cathode active material selected from Na_{0.7}CoO₂, Na_{0.67}Ni_{0.25}Mg_{0.1}Mn_{0.65}O₂, Na_{0.5}[Ni_{0.23}Fe_{0.13}Mn_{0.63}]O₂, Na_{0.85}Li_{0.17}Ni_{0.21}Mn_{0.64}O₂, Zn doped Na_{0.833}[Li_{0.25}Mn_{0.75}]O₂, Na_{0.7}Mg_{0.05}[Mn_{0.6}Ni_{0.2}Mg_{0.15}]O₂, Na_{0.66}Co_{0.5}Mn_{0.5}O₂, Na_{2/3}Li_{1/9}Ni_{5/18}Mn_{2/3}O₂, C-coated NaCrO₂, Na_{0.9}[Cu_{0.22}Fe_{0.30}Mn_{0.48}]O₂, Na[Ni_{0.58}Co_{0.06}Mn_{0.36}]O₂, Na_{0.75}Ni_{0.82}Co_{0.12}Mn_{0.06}O₂, NaMn_{0.48}Ni_{0.2}Fe_{0.3}Mg_{0.02}O₂, V₂O₅ nanosheet, Na₃V₂(PO₄)₃, Na₃V₂(PO₄)₃/C, Na₃MnZr(PO₄)₃, Na₄Fe₃(PO₄)₂(P₂O₇), Na₃MnTi(PO₄)₃/C, carbon coated Na₃V₂(PO₄)₂F₃, Na₃(VOPO₄)₂F, graphene oxide protected Na₂₊₂ₓFe₂₋ₓ(SO₄)₃, Na_{2.3}Cu_{1.1}Mn₂O_{7-d}, graphene oxide protected Na₂FeP₂O₇, graphene oxide protected Na_{0.81}Fe[Fe(CN)₆]_{0.79-0.61}, Na₂CoFe(CN)₆, Ni_{0.67}Fe_{0.33}Se₂, or a combination thereof.

The present disclosure also provides a process for manufacturing the rechargeable sodium cell, the process comprising:
(a) providing an anode comprising an anode current collector, or an anode current collector plus an active material layer wherein the anode active material layer is supported on a primary surface of the anode current collector;
(b) providing a cathode comprising a cathode active material layer supported on a primary surface of an anode current collector;
(c) depositing an elastic polymer electrolyte separator on the anode current collector (if no active material layer is present), the anode active material layer, or the cathode active material layer;
(d) combining the anode, the elastic polymer electrolyte separator, and the cathode to form a cell wherein the elastic polymer electrolyte separator is disposed between the anode and the cathode; and
(e) encasing the cell in a protective housing to form the rechargeable sodium cell.

In some embodiments, step (c) comprises (A) providing (i) a liquid polymer solution comprising a high-elasticity polymer dissolved in a liquid solvent or (ii) a liquid reactive mass (e.g., a monomer and initiator or an oligomer and a crosslinking agent, etc.) as a precursor to a high-elasticity polymer; (B) dispensing and depositing a layer of the liquid solution or the liquid reactive mass onto a solid substrate surface, wherein the solid substrate is the anode current collector, the anode active material layer, or the cathode active material layer; and (C) removing the liquid solvent from the liquid polymer solution to precipitate out the high-elasticity polymer or polymerizing and/or curing the reactive mass to form the layer of high-elasticity polymer separator.

The liquid polymer solution or the liquid reactive mass may comprise a sodium salt and/or a sodium ion-conducting material dissolved or dispersed therein.

The process may be practiced as a roll-to-roll process wherein step (B) comprises (1) continuously feeding a layer of the solid substrate from a feeder roller to a dispensing zone where the liquid polymer solution or the reactive mass is dispensed and deposited onto the solid substrate to form a continuous layer of the liquid polymer solution or the reactive mass; and (2) moving the layer of the liquid polymer solution or the reactive mass into a reacting zone where the liquid polymer solution or the reactive mass is subjected to solvent removal or exposed to heat, ultraviolet light, or high-energy radiation to polymerize and/or cure the reactive mass to form a continuous layer of elastic polymer supported on the solid substrate.

In some embodiments, the solid substrate comprises an anode current collector or an anode active material layer supported on an anode current collector and the process further comprises continuously feeding a cathode active material layer (supported on a cathode current collector) and covering the elastic polymer layer with the cathode active material layer to form a multi-layer structure. The process may further include winding and collecting the multi-layer structure on a winding roller. The process may further comprise cutting and trimming said multi-layer structure to form multiple pieces of battery cells.

These and other advantages and features of the present disclosure will become more transparent with the description of the following best mode practice and illustrative examples.

### BRIEF DESCRIPTION OF THE DRAWINGS

FIG. 1 Schematic of a prior art sodium metal battery cell, containing an anode layer (a thin Na foil or Na coating deposited on a surface of a current collector, Cu foil), a porous separator, and a cathode active material layer, which is composed of particles of a cathode active material, a conductive additive (not shown) and a resin binder (not shown). A cathode current collector supporting the cathode active layer is also shown.

FIG. 2(A) Schematic of a presently invented sodium metal battery cell (upper diagram) containing an anode current collector (e.g., Cu foil) but no anode active material (when the cell is manufactured or in a fully discharged state), an elastic polymer separator, and a cathode active material layer, which is composed of particles of a cathode active material, a conductive additive (not shown) and a resin binder (not shown). A cathode current collector supporting the cathode active layer is also shown. The lower diagram shows a thin lithium metal layer deposited between the Cu foil and the elastic polymer separator layer when the battery is in a charged state;

FIG. 2(B) Schematic of a presently invented sodium-ion battery cell.

FIG. 3 Schematic of an elastic polymer separator layer wherein the plastic crystals or organic domains are uniformly dispersed in a matrix of high-elasticity polymer according to some embodiments of the present disclosure.

FIG. 4 Schematic of a roll-to-roll process for producing rolls of elastic composite separator in a continuous manner.

### DETAILED DESCRIPTION

In certain embodiments, the presently disclosed rechargeable sodium cell comprises an anode, a cathode, and an elastic polymer separator disposed between the cathode and the anode, wherein the elastic polymer separator has a thickness from 10 nm to 100 μm (preferably less than 50 μm and more preferably less than 20 μm) and comprises a high-elasticity polymer having a sodium ion conductivity from 10⁻⁸ S/cm to 5×10⁻² S/cm (preferably greater than10⁻⁵ S/cm, more preferably greater than 10⁻⁴ S/cm, and most preferably greater than 10⁻³ S/cm) at room temperature and a fully recoverable tensile strain from 2% to 1,000% (preferably >10%, more preferably >50%, and further preferably >100%) when measured without any additive dispersed therein. The cell can be a sodium metal cell, sodium-ion cell, or sodium-sulfur cell

In certain embodiments, the rechargeable sodium cell is a sodium metal cell wherein the anode has an anode current collector but initially the anode has no sodium or sodium alloy as an anode active material supported by the anode current collector when the battery cell is made and prior to a charge or discharge operation of the battery. In this situation, the sodium ions are initially stored in the cathode, as part of a cathode active material.

In certain embodiments, the rechargeable sodium cell is a sodium metal cell wherein the anode has an anode current collector and an amount of sodium or sodium alloy (e.g., in the form of powder, coating, or thin film) as an anode active material supported by the anode current collector.

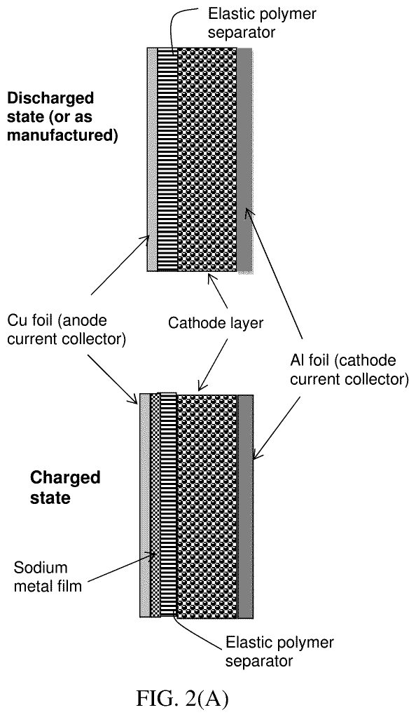

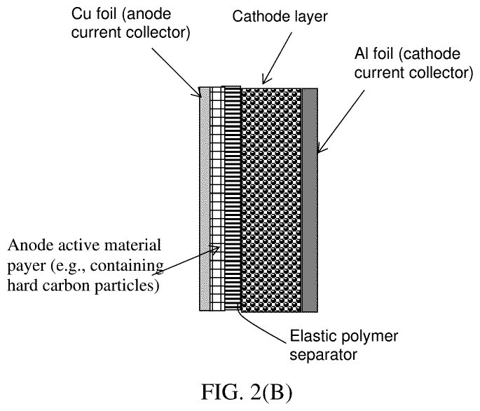

In some embodiments, the rechargeable sodium cell is a sodium-ion cell (e.g., FIG. 2(B)) wherein the anode active material contains an alkali intercalation compound.

In a typical configuration, the separator is in ionic contact with both the anode and the cathode and typically in physical contact with an anode active material layer (or an anode current collector) and with a cathode active material layer. The anode and/or the cathode may also contain a working electrolyte to facilitate sodium ion transport in the electrodes. Thus, a battery cell may further comprise, in addition to the elastic polymer separator serving as a solid electrolyte, a working electrolyte in ionic contact with an anode active material and/or a cathode active material wherein the working electrolyte is selected from an organic liquid electrolyte, ionic liquid electrolyte, polymer gel electrolyte, solid polymer electrolyte different than the high-elasticity polymer, inorganic solid electrolyte, quasi-solid electrolyte having a sodium salt dissolved in an organic or ionic liquid with a sodium salt concentration higher than 2.0 M (preferably from 2.5M to 14 M), or a combination thereof.

In the rechargeable sodium cell, the high-elasticity polymer may comprise an elastomer or rubber selected from natural polyisoprene, synthetic polyisoprene, polybutadiene, chloroprene rubber, polychloroprene, butyl rubber, butyl acrylic rubber, poly(butyl diacrylate), styrene-butadiene rubber, nitrile rubber, ethylene propylene rubber, ethylene propylene diene rubber, metallocene-based poly(ethylene-co-octene) elastomer, poly(ethylene-co-butene) elastomer, styrene-ethylene-butadiene-styrene elastomer, epichlorohydrin rubber, polyacrylic rubber, silicone rubber, fluorosilicone rubber, perfluoroelastomers, polyether block amides, chlorosulfonated polyethylene, ethylene-vinyl acetate, thermoplastic elastomer, protein resilin, protein elastin, ethylene oxide-epichlorohydrin copolymer, polysiloxane, poly(alkyl siloxane), polyurethane, urethane-urea copolymer, urethane-acrylic copolymer, a copolymer thereof, a sulfonated version thereof, or a combination thereof.

We have discovered that this elastic polymer layer provides several unexpected benefits: (a) the formation and penetration of dendrite can be essentially eliminated; (b) uniform deposition of sodium back to the anode side is readily achieved during battery charging; (c) the layer ensures smooth and uninterrupted transport of sodium ions to/from the anode current collector surface (or the sodium film deposited thereon during the battery operations) and through the interface between the current collector (or the sodium film deposited thereon) and the elastic polymer separator layer with minimal interfacial resistance; (d) the elastic polymer, having a high elasticity (high recoverable elastic deformation), is capable of accommodating the large volume expansion or shrinkage of the sodium metal layer during the charge and discharge of the sodium metal battery, reducing or eliminating the need to provide a high clamping pressure on the battery cell, module, or stack; and (e) cycle stability can be significantly improved and cycle life increased. No additional protective layer for the sodium metal anode is required. The separator itself also plays the role as an anode protective layer.

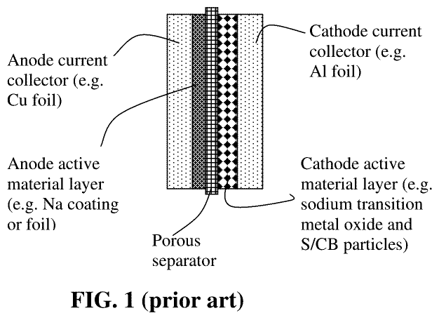

In a conventional sodium metal cell, as illustrated in FIG. 1, the anode active material (sodium) is deposited in a thin film form or a thin foil form directly onto an anode current collector (e.g., a Cu foil) before this anode and a cathode are combined to form a cell. The battery is a sodium metal battery, sodium-air battery, sodium-sulfur battery, sodium-selenium battery, etc. As previously discussed in the Background section, these sodium secondary batteries have the dendrite-induced internal shorting and “dead sodium” issues at the anode.

We have solved these challenging issues that have troubled battery designers and electrochemists alike for more than 30 years by developing and implementing a new elastic polymer separator disposed between the anode (an anode current collector or an anode active material layer) and a cathode active material layer. This elastic polymer separator layer comprises a high-elasticity polymer having a recoverable (elastic) tensile strain no less than 2% (preferably no less than 5%, and further preferably from 10% to 500%) under uniaxial tension and a sodium ion conductivity no less than 10⁻⁶ S/cm at room temperature (preferably and more typically from 1×10⁻⁵ S/cm to 5×10⁻² S/cm).

As schematically shown in FIG. 2(A), one embodiment of the present disclosure is a sodium metal battery cell containing an anode current collector (e.g., Cu foil), a high-elasticity polymer-based separator (a polymer solid-state electrolyte), and a cathode active material layer, which is composed of particles of a cathode active material, a conductive additive (not shown) and a resin binder (not shown). A cathode current collector (e.g., Al foil) supporting the cathode active layer is also shown in FIG. 2(A).

The high-elasticity polymer material refers to a material (polymer) that exhibits an elastic deformation of at least 2% when measured under uniaxial tension. In the field of materials science and engineering, the “elastic deformation” is defined as a deformation of a material (when being mechanically stressed) that is essentially fully recoverable and the recovery is essentially instantaneous upon release of the load. The elastic deformation is preferably greater than 5%, more preferably greater than 10%, further more preferably greater than 30%, and still more preferably greater than 100% (up to 500%).

It may be noted that FIG. 2(B) shows an example of a sodium metal battery that initially does not contain a sodium foil or sodium coating at the anode (only an anode current collector, such as a Cu foil or a graphene/CNT mat) when the battery is made. The needed sodium to be bounced back and forth between the anode and the cathode is initially stored in the cathode active material (e.g., NaFePO₄, Na_{0.7}FePO₄, Na_{1.5}VOPO₄F_{0.5}, Na₃V₂(PO₄)₃, etc.). During the first charging procedure of the sodium battery (e.g., as part of the electrochemical formation process), sodium comes out of the cathode active material, passes through the elastic polymer separator and deposits on the anode current collector. The presence of the presently invented high-elasticity polymer separator (in good contact with the current collector) enables the uniform deposition of sodium ions on the anode current collector surface. Such a battery configuration avoids the need to have a layer of sodium foil or coating being present during battery fabrication. Bare sodium metal is highly sensitive to air moisture and oxygen and, thus, is more challenging to handle in a real battery manufacturing environment. This strategy of pre-storing sodium in the sodiated (sodium-containing) cathode active materials makes all the materials safe to handle in a real manufacturing environment. Cathode active materials are typically not air-sensitive.

As the charging procedure continues, more sodium ions get to deposit onto the anode current collector, forming a sodium metal film or coating. During the subsequent discharge procedure, this sodium film or coating layer decreases in thickness due to dissolution of sodium into the electrolyte to become sodium ions, creating a gap between the current collector and the protective layer if the separator layer were not elastic. Such a gap would make the re-deposition of sodium ions back to the anode challenging or impossible during a subsequent recharge procedure. We have observed that the elastic polymer separator layer is capable of expanding or shrinking congruently or conformably with the anode layer. This capability helps to maintain a good contact between the current collector (or the sodium film subsequently or initially deposited on the current collector surface) and the protective layer, enabling the re-deposition of sodium ions without interruption.

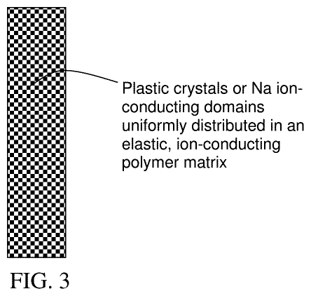

FIG. 3 schematically shows an elastic polymer separator layer wherein plastic crystals or ion-conducting domains are uniformly dispersed in a matrix of an elastic polymer according to some embodiments of the present disclosure. A plastic crystal or ionic conducting domain typically comprises an integrated mixture or complex of a sodium salt with either a plastic crystal or organic species that help to hold the sodium salt together to form a domain. Such a plastic crystal or domain naturally resides in interstices between chains of an elastic polymer. This phase typically has a sodium ion conductivity higher than the high-elasticity polymer. Hence, this plastic crystal or ion-conducting domain phase imparts sodium ion conductivity to the high-elasticity polymer and the high-elasticity polymer provides the desired mechanical flexibility to the battery cell.

In some embodiments, the high-elasticity polymer comprises an elastomer selected from natural polyisoprene (e.g. cis-1,4-polyisoprene natural rubber (NR) and trans-1,4-polyisoprene gutta-percha), synthetic polyisoprene (IR for isoprene rubber), polybutadiene (BR for butadiene rubber), chloroprene rubber (CR), polychloroprene (e.g. Neoprene, Baypren etc.), butyl rubber (copolymer of isobutylene and isoprene, IIR), including halogenated butyl rubbers (chloro butyl rubber (CIIR) and bromo butyl rubber (BIIR), butyl acrylic rubber, styrene-butadiene rubber (copolymer of styrene and butadiene, SBR), nitrile rubber (copolymer of butadiene and acrylonitrile, NBR), EPM (ethylene propylene rubber, a copolymer of ethylene and propylene), EPDM rubber (ethylene propylene diene rubber, a terpolymer of ethylene, propylene and a diene-component), epichlorohydrin rubber (ECO), polyacrylic rubber (ACM, ABR), silicone rubber (SI, Q, VMQ), fluorosilicone rubber (FVMQ), fluoroelastomers (FKM, and FEPM; such as Viton, Tecnoflon, Fluorel, Aflas and Dai-El), perfluoroelastomers (FFKM: Tecnoflon PFR, Kalrez, Chemraz, Perlast), polyether block amides (PEBA), chlorosulfonated polyethylene (CSM; e.g. Hypalon), and ethylene-vinyl acetate (EVA), thermoplastic elastomers (TPE), protein resilin, protein elastin, ethylene oxide-epichlorohydrin copolymer, polyurethane, urethane-urea copolymer, and combinations thereof.

In some preferred embodiments, the high-elasticity polymer contains a lightly cross-linked network of polymer chains having an ether linkage, nitrile-derived linkage, benzo peroxide-derived linkage, ethylene oxide linkage, ethylene glycol linkage (e.g., ethylene glycol diacrylate chains), propylene oxide linkage, vinyl alcohol linkage, cyano-resin linkage, triacrylate monomer-derived linkage, tetraacrylate monomer-derived linkage, or a combination thereof, in the cross-linked network of polymer chains having a degree of crosslinking that affords an elasticity of the polymer in the range from 5% to 1,000%. These network or cross-linked polymers exhibit a unique combination of a high elasticity (high elastic deformation strain) and high lithium-ion conductivity.

In certain preferred embodiments, the high-elasticity polymer contains a lightly cross-linked network polymer chains selected from nitrile-containing polyvinyl alcohol chains, cyanoresin chains, pentaerythritol tetraacrylate (PETEA) chains, pentaerythritol triacrylate chains, ethoxylated trimethylolpropane triacrylate (ETPTA) chains, ethylene glycol methyl ether acrylate (EGMEA) chains, poly(ethylene glycol) diacrylate (PEGDA) chains, acrylic acid-derived chains, polyvinyl alcohol chains, or a combination thereof.

The elastic polymer separator may further comprise from 0.1% to 70% by weight of a sodium ion-conducting material (ion conductivity enhancer) dispersed or dissolved in the high-elasticity polymer. Such a sodium ion-conducting material may be selected from a sodium salt, an inorganic solid electrolyte material (e.g., Nasicon, beta-alumina, sulfide-type, complex hydride-type, etc.), and/or an organic (polymeric) electrolyte.

The sodium ion-conducting material may comprise an inorganic solid electrolyte material having a sodium ion conductivity no less than 10⁻⁸ S/cm, preferably no less than 10⁻⁶ S/cm, more preferably no less than 10⁻⁴ S/cm, and most preferably no less than 10⁻³ S/cm. Complex hydride type solid-state electrolytes can have a sodium ion conductivity greater than 10⁻² S/cm.

Several different types of Nat-ion solid-state electrolytes (SSE) are available as an ion conductivity enhancer. These include beta-alumina, NASICON, sulfide-based electrolytes, complex hydrides, and organic electrolytes. NASICON materials include Na₁₊ₓZr₂SiₓP₃₋ₓO₁₂ (0≤x≤3). This abbreviation is used for phosphates with the generic formula AMP₃O₁₂. In this family of compositions, a wide variation of substitutions has been reported. For instance, the A-site can be occupied by:
monovalent cations: Li⁺, Na⁺, K⁺, Rb⁺, Cs⁺, H⁺, H₃O⁺, NH⁴⁺, Cu⁺, Ag⁺,
divalent cations: Mg²⁺, Ca²⁺, Sr²⁺, Ba²⁺, Cu²⁺, Pb²⁺, Cd²⁺, Mn²⁺, Co²⁺, Ni²⁺, Zn²⁺,
trivalent cations: Al³⁺, Y³⁺, La³⁺-Lu³⁺,
tetravalent cations: Ge⁴⁺, Zr⁴⁺, Hf⁴⁺;
   Or it can also be vacant in the case that the M-site is occupied by pentavalent cations. The M sites can be occupied by:
divalent cations: Cd²⁺, Mn²⁺, Ce²⁺, Ni²⁺, Zn²⁺,
trivalent cations: Al³⁺, Ga³⁺, In³⁺, Sc³⁺, Ti³⁺, V³⁺, Cr³⁺, Fe³⁺, Y³⁺, La³⁺-Lu³⁺,
tetravalent cations: Si⁴⁺, Ge⁴⁺, Sn⁴⁺, Ti⁴⁺, Zr⁴⁺, Hf⁴⁺, V⁴⁺, Nb⁴⁺, Mo⁴⁺, and
pentavalent cations: V⁵⁺, Nb⁵⁺, Ta⁵⁺, Sb⁵⁺, As⁵⁺to balance the charge suitably. In addition, phosphorus has been partially substituted by Si, Ge or As.

In certain embodiments, the sodium ion-conducting material comprises a sodium salt selected from sodium perchlorate (NaClO₄), sodium chlorate (NaClO₃), sodium hexafluorophosphate (NaPF₆), sodium borofluoride (NaBF₄), sodium hexafluoroarsenide, sodium trifluoro-metasulfonate (NaCF₃SO₃), bis-trifluoromethyl sulfonylimide sodium (NaN(CF₃SO₂)₂), sodium trifluoromethanesulfonimide (NaTFSI), sodium bis(fluoroallyl) malonato borate salt (NaBFMB), sodium poly(tartaric acid)borate (NaPTAB) salt, NaCF₃COO, Na₂CO₃, Na₂O, Na₂C₂O₄, NaOH, NaX, ROCO₂Na, HCONa, RONa, (ROCO₂Na)₂, (CH₂OCO₂Na)₂, Na₂S, NaₓSO_{y}, wherein X═F, Cl, I, or Br, R=a hydrocarbon group, x=0-1, y=1-4, or a combination thereof.

The high-elasticity polymer may form a mixture, blend, copolymer, crosslinked network, or interpenetrating network with a sodium ion-conducting polymer selected from poly(ethylene oxide) (PEO), Polypropylene oxide (PPO), polyethylene glycol (PEG), polyvinyl alcohol (PVA), poly(vinyl pyrrolidone) (PVP), poly(ethyl methacrylate) (PEMA), poly(acrylonitrile) (PAN), poly(methyl methacrylate) (PMMA), poly(vinylidene fluoride) (PVdF), Poly bis-methoxy ethoxyethoxide-phosphazenex, Polyvinyl chloride, Polydimethylsiloxane, poly(vinylidene fluoride)-hexafluoropropylene (PVDF-HFP), a sulfonated derivative thereof, or a combination thereof.

In some preferred embodiments, the high-elasticity polymer comprises from 5% to 95% by weight (preferably from 25% to 75%, more preferably from 35% to 65%, and most preferably from 45% to 55%) of a sodium ion-conducting plastic crystal or plasticizer dispersed in or connected to the high-elasticity polymer. Preferably, the high-elasticity polymer and the plastic crystal or organic plasticizer form co-continuous phases exhibiting a sodium-ion conductivity no less than 10⁻⁵ S/cm, preferably higher than 10⁻³ S/cm.

The plastic crystal or organic domain phase typically and desirably comprises a mixture of a sodium salt and a sodium ion conducting organic species. These organic species preferably have a relatively high dielectric constant (preferably >5, more preferably >20, and further preferably >50) that is conducive to dissolving a suitable amount of a sodium salt. The mixture should also have chemical compatibility with the crosslinked network of chains and can be readily impregnated into the nano-scaled spaces between these chains. The chains of the elastic polymer serve to hold the mixture in place.

The plastic crystal or organic plasticizer may comprise a mixture of a sodium salt and a sodium ion-conducting organic species selected from a fluorinated carbonate, hydrofluoroether, fluorinated vinyl carbonate, fluorinated ester, fluorinated vinyl ester, fluorinated vinyl ether, sulfone, sulfide, nitrile, phosphate, phosphite, phosphonate, sulfate, siloxane, silane 1,3-dioxolane (DOL), 1,2-dimethoxyethane (DME), tetraethylene glycol dimethylether (TEGDME), poly(ethylene glycol) dimethyl ether (PEGDME), diethylene glycol dibutyl ether (DEGDBE), 2-ethoxyethyl ether (EEE), sulfolane, acetonitrile (AN), acrylonitrile, succinoniitrile, fluoroethylene carbonate (FEC), an ionic liquid solvent, a polymerized version thereof, or a combination thereof.

The polymerized versions of these polymers preferably have a low molecular weight, having a number average molecular weight, Mn, preferably less than 10,000 g/mole (more preferably <5,000 g/mole and further more preferably <2,000 g/mole).

The presence of this organic species is designed to impart certain desired properties to the polymer electrolyte, such as sodium-ion conductivity and flame retardancy. For instance, desirable organic species include fluorinated solvents that are preferably polymerizable or curable; e.g., fluorinated vinyl carbonates, fluorinated esters, fluorinated vinyl esters, and fluorinated vinyl ethers. Fluorinated vinyl esters include R_{f}CO₂CH═CH₂ and Propenyl Ketones, R_{f}COCH═CHCH₃, where R_{f} is F or any F-containing functional group (e.g., CF₂— and CF₂CF₃—).

Two examples of fluorinated vinyl carbonates are given below:

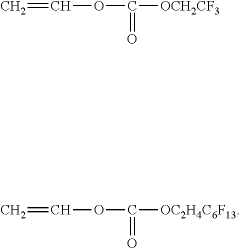

In some embodiments, the fluorinated carbonate is selected from fluoroethylene carbonate (FEC), DFDMEC, FNPEC, hydrofluoro ether trifluoro propylene carbonate (FPC), or methyl nonafluorobutyl ether (MFE), wherein the chemical formulae for FEC, DFDMEC, and FNPEC, respectively are shown below:

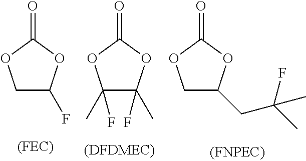

Desirable sulfones as a plastic crystal precursor or organic plasticizer include, but not limited to, alkyl and aryl vinyl sulfones or sulfides; e.g., ethyl vinyl sulfide, allyl methyl sulfide, phenyl vinyl sulfide, phenyl vinyl sulfoxide, ethyl vinyl sulfone, allyl phenyl sulfone, allyl methyl sulfone, and divinyl sulfone:

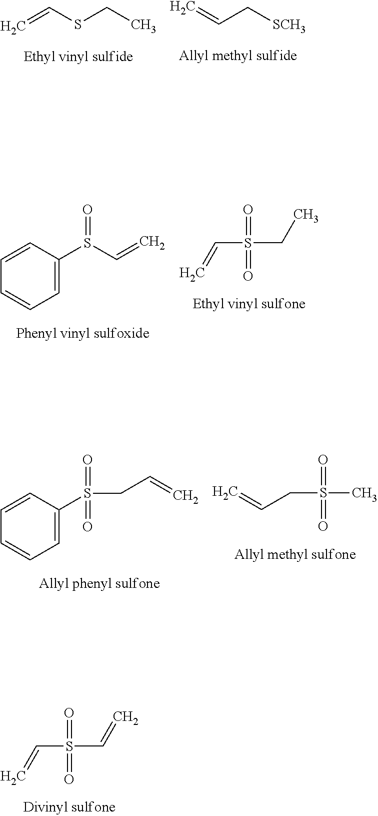

In certain embodiments, the sulfone as a plastic crystal precursor or organic plasticizer is selected from TrMS, MTrMS, TMS, or vinyl or double bond-containing variants of TrMS, MTrMS, TMS, EMS, MMES, EMES, EMEES, or a combination thereof; their chemical formulae being given below:

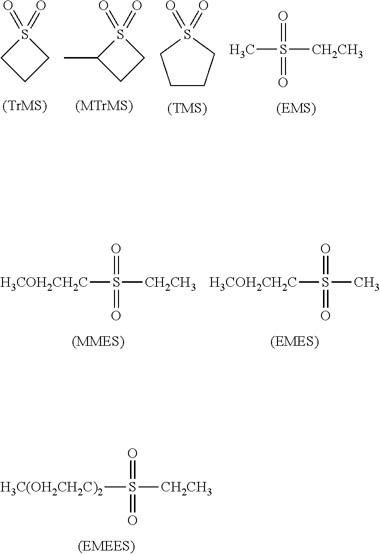

The nitrile as a plastic crystal precursor or organic plasticizer may be selected from a dinitrile, such as AND, GLN, SEN, succinonitrile, or a combination thereof and their chemical formulae are given below:

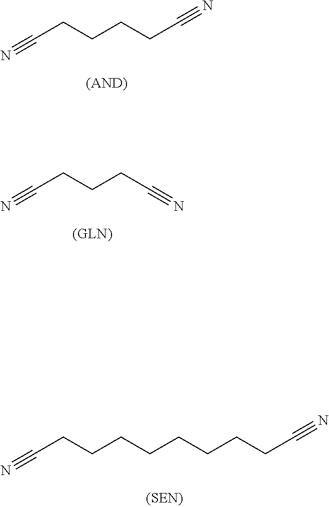 [SMILES: N#CCCCCC#N ; N#CCCCC#N ; N#CCCCCCCCCC#N]

In some embodiments, the plastic crystal precursor or organic plasticizer is selected from phosphate. alkyl phosphonate, phosphazene, phosphite, or sulfate; e.g., tris(trimethylsilyl) phosphite (TTSPi), alkyl phosphate, triallyl phosphate (TAP), ethylene sulfate (DTD), a combination thereof, or a combination with 1,3-propane sultone (PS) or propene sultone (PES). The phosphate, alkyl phosphonate, or phosphazene may be selected from the following:

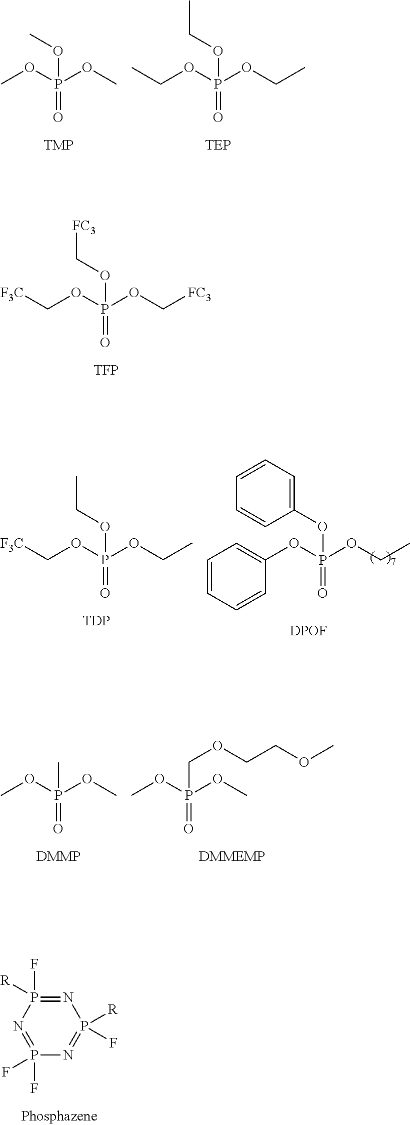

wherein R═H, NH₂, or C₁-C₆ alkyl.

The disclosed organic species may be initially in a reactive liquid form that can be co-cured or co-polymerized with the precursor monomer/oligomer of an intended elastic polymer. The disclosed organic species may comprise a lithium salt and an initiator, a substituent, a co-monomer, or a crosslinking agent dissolved or dispersed in a reactive liquid medium comprising a reactive elastomer precursor (monomer, oligomer, or reactive polymer). The organic species are then co-polymerized or co-cured with the elastomer, forming an intimate blend, co-polymer, interpenetrating network, etc.

Typically, a high-elasticity polymer is originally in a monomer or oligomer states that can be cured to form a cross-linked polymer that is highly elastic. Prior to curing, these polymers or oligomers are soluble in an organic solvent to form a polymer solution. An ion-conducting additive may be added to this solution to form a suspension. This solution or suspension can then be formed into a thin layer of polymer precursor on a surface of (i) an anode current collector, (ii) lithium metal layer, or (iii) cathode active material layer. The polymer precursor (monomer or oligomer and initiator) is then polymerized and cured to form a lightly cross-linked polymer. Alternatively, a thin layer of such an elastic polymer may be tentatively deposited on a solid substrate (e.g., surface of a polymer or glass), dried, and separated from the substrate to become a free-standing polymer layer. This free-standing layer is then laid on a lithium foil/coating (or anode current collector) and a cathode layer. Polymer layer formation can be accomplished by using one of several procedures well-known in the art; e.g., spraying, spray-painting, printing, coating, extrusion-based film-forming, casting, etc.

For instance, ethoxylated trimethylopropane triacrylate monomer (ETPTA, Mw=428, chemical formula given below), along with an initiator, can be dissolved in an organic solvent, such as ethylene carbonate (EC) or diethyl carbonate (DEC). Then, the ETPTA monomer/solvent/initiator solution may be cast to form ETPTA a monomer/initiator layer on a glass surface. The layer can then be thermally cured to obtain a thin layer of a high-elasticity polymer. The polymerization and cross-linking reactions of this monomer can be initiated by a radical initiator derived from benzoyl peroxide (BPO) or AIBN through thermal decomposition of the initiator molecule. The ETPTA monomer has the following chemical formula:

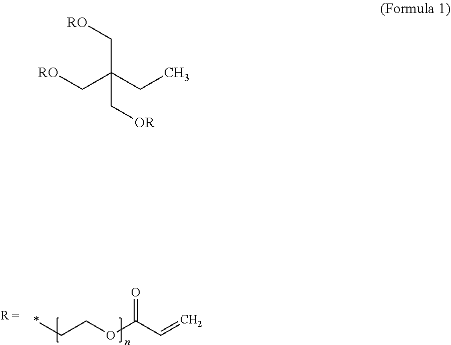

As another example, the high-elasticity polymer for anode lithium foil/coating protection may be based on cationic polymerization and cross-linking of the cyanoethyl polyvinyl alcohol (PVA-CN, Formula 2) in succinonitrile (SN).

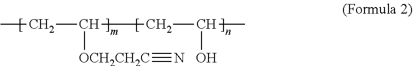

The procedure may begin with dissolving PVA-CN in succinonitrile (NCCH₂CH₂CN) to form a mixture solution. This is followed by adding an initiator into the mixture solution. For instance, LiPF₆ can be added into the PVA-CN/SN mixture solution at a weight ratio (selected from the preferred range from 20:1 to 2:1) to form a precursor solution. Then, the solution may be deposited to form a thin layer of reacting mass, PVA-CN/LiPF₆, which is subsequently heated at a temperature (e.g., from 75 to 100° C.) for 2 to 8 hours to obtain a high-elasticity polymer. During this process, cationic polymerization and cross-linking of cyano groups on the PVA-CN may be initiated by PF₅, which is derived from the thermal decomposition of LiPF₆ at such an elevated temperature.

It is essential for these materials to form a lightly cross-linked network of polymer chains. In other words, the network polymer or cross-linked polymer should have a relatively low degree of cross-linking or low cross-link density to impart a high elastic deformation.

The cross-link density of a cross-linked network of polymer chains may be defined as the inverse of the molecular weight between cross-links (Mc). The cross-link density can be determined by the equation, Mc=ρRT/Ge, where Ge is the equilibrium modulus as determined by a temperature sweep in dynamic mechanical analysis, ρ is the physical density, R is the universal gas constant in J/mol*K and T is absolute temperature in K. Once Ge and ρ are determined experimentally, then Mc and the cross-link density can be calculated.

The magnitude of Mc may be normalized by dividing the Mc value by the molecular weight of the characteristic repeat unit in the cross-link chain or chain linkage to obtain a number, Nc, which is the number of repeating units between two cross-link points. We have found that the elastic deformation strain correlates very well with Mc and Nc. The elasticity of a cross-linked polymer derives from a large number of repeating units (large Nc) between cross-links. The repeating units can assume a more relax conformation (e.g. random coil) when the polymer is not stressed. However, when the polymer is mechanically stressed, the linkage chain uncoils or gets stretched to provide a large deformation. A long chain linkage between cross-link points (larger Nc) enables a larger elastic deformation. Upon release of the load, the linkage chain returns to the more relaxed or coiled state. During mechanical loading of a polymer, the cross-links prevent slippage of chains that otherwise form plastic deformation (non-recoverable).

Preferably, the Nc value in a high-elasticity polymer is greater than 5, more preferably greater than 10, further more preferably greater than 100, and even more preferably greater than 200. These Nc. values can be readily controlled and varied to achieve different elastic deformation values by using different cross-linking agents with different functionalities, and by designing the polymerization and cross-linking reactions to proceed at different temperatures for different periods of time.

Alternatively, Mooney-Rilvin method may be used to determine the degree of cross-linking. Crosslinking also can be measured by swelling experiments. In a swelling experiment, the crosslinked sample is placed into a good solvent for the corresponding linear polymer at a specific temperature, and either the change in mass or the change in volume is measured. The higher the degree of crosslinking, the less swelling is attainable. Based on the degree of swelling, the Flory Interaction Parameter (which relates the solvent interaction with the sample, Flory Huggins Eq.), and the density of the solvent, the theoretical degree of crosslinking can be calculated according to Flory's Network Theory. The Flory-Rehner Equation can be useful in the determination of cross-linking.

The high-elasticity polymer may contain a simultaneous interpenetrating network (SIN) polymer, wherein two cross-linking chains intertwine with each other, or a semi-interpenetrating network polymer (semi-IPN), which contains a cross-linked polymer and a linear polymer. An example of semi-IPN is an UV-curable/polymerizable trivalent/monovalent acrylate mixture, which is composed of ethoxylated trimethylolpropane triacrylate (ETPTA) and ethylene glycol methyl ether acrylate (EGMEA) oligomers. The ETPTA, bearing trivalent vinyl groups, is a photo (UV)-crosslinkable monomer, capable of forming a network of cross-linked chains. The EGMEA, bearing monovalent vinyl groups, is also UV-polymerizable, leading to a linear polymer with a high flexibility due to the presence of the oligomer ethylene oxide units. When the degree of cross-linking of ETPTA is moderate or low, the resulting ETPTA/EGMEA semi-IPN polymer provides good mechanical flexibility or elasticity and reasonable mechanical strength. The lithium-ion conductivity of this polymer is in the range of 10⁻⁴ to 5×10⁻³ S/cm.

The aforementioned high-elasticity polymers may be used alone to serve as a separator layer. A broad array of elastomers can be used alone as an elastic polymer or mixed with a high-elasticity polymer to form a blend, co-polymer, or interpenetrating network that encapsulates the cathode active material particles.

The urethane-urea copolymer film usually consists of two types of domains, soft domains and hard ones. Entangled linear backbone chains consisting of poly (tetramethylene ether) glycol (PTMEG) units constitute the soft domains, while repeated methylene diphenyl diisocyanate (MDI) and ethylene diamine (EDA) units constitute the hard domains. The lithium ion-conducting additive can be incorporated in the soft domains or other more amorphous zones.

Unsaturated rubbers that can be used as an elastic polymer include natural polyisoprene (e.g. cis-1,4-polyisoprene natural rubber (NR) and trans-1,4-polyisoprene gutta-percha), synthetic polyisoprene (IR for isoprene rubber), polybutadiene (BR for butadiene rubber), chloroprene rubber (CR), polychloroprene (e.g. Neoprene, Baypren etc.), butyl rubber (copolymer of isobutylene and isoprene, IIR), including butyl acrylate rubber, and halogenated butyl rubbers (chloro butyl rubber (CIIR) and bromo butyl rubber (BIIR)) and the derivatives thereof, styrene-butadiene rubber (copolymer of styrene and butadiene, SBR), nitrile rubber (copolymer of butadiene and acrylonitrile, NBR), etc.

Some elastomers are saturated rubbers that cannot be cured by sulfur vulcanization; they are made into a rubbery or elastomeric material via different means: e.g., by having a copolymer domain that holds other linear chains together. Each of these elastomers can be used to bond particles of a cathode active material by one of several means; e.g., spray coating, dilute solution mixing (dissolving the cathode active material particles in an uncured polymer, monomer, or oligomer, with or without an organic solvent) followed by drying and curing.

Saturated rubbers and related elastomers in this category include EPM (ethylene propylene rubber, a copolymer of ethylene and propylene), EPDM rubber (ethylene propylene diene rubber, a terpolymer of ethylene, propylene and a diene-component), epichlorohydrin rubber (ECO), polyacrylic rubber (ACM, ABR), silicone rubber (SI, Q, VMQ), fluorosilicone rubber (FVMQ), fluoroelastomers (FKM, and FEPM; such as Viton, Tecnoflon, Fluorel, Aflas and Dai-E1), perfluoroelastomers (FFKM: Tecnoflon PFR, Kalrez, Chemraz, Perlast), polyether block amides (PEBA), chlorosulfonated polyethylene (CSM; e.g. Hypalon), and ethylene-vinyl acetate (EVA), thermoplastic elastomers (TPE), protein resilin, and protein elastin. Polyurethane and its copolymers (e.g., urea-urethane copolymer) are particularly useful elastomeric shell materials for encapsulating anode active material particles.

The rechargeable sodium cell may be a sodium-ion cell wherein the anode active material contains an alkali intercalation compound selected from meso-phase pitch, meso-phase carbon, meso carbon micro-beads (MCMB), coke particles (e.g., needle coke), expanded graphite flakes, artificial graphite particles, natural graphite particles, highly oriented pyrolytic graphite, soft carbon particles, hard carbon particles, multi-walled carbon nanotubes, carbon nano-fibers, carbon fibers, graphite nano-fibers, graphite fibers, carbonized polymer fibers, carbon black, amorphous carbon, activated carbon, templated carbon, hollow carbon nanowires, hollow carbon sphere, silicon (Si), phosphorus (P), sodium titanates, NaTi₂(PO₄)₃, Na₂Ti₃O₇, Na₂C₈H₄O₄, Na₂TP, NaₓTiO₂ (x=0.2 to 1.0), disodium terephthalate (Na₂C₈H₄O₄), carboxylate based materials, C₈H₄Na₂O₄, C₈H₆O₄, C₈H₅NaO₄, C₈Na₂F₄O₄, C₁₀H₂Na₄O₈, C₁₄H₄O₆, C₁₄H₄Na₄O₈, or a combination thereof.

The alkali intercalation compound or alkali-containing compound as an anode active material may be selected from the following groups of materials: (a) Sodium- or potassium-doped silicon (Si), germanium (Ge), tin (Sn), lead (Pb), antimony (Sb), bismuth (Bi), zinc (Zn), aluminum (Al), titanium (Ti), cobalt (Co), nickel (Ni), manganese (Mn), cadmium (Cd), and mixtures thereof; (b) Sodium- or potassium-containing alloys or intermetallic compounds of Si, Ge, Sn, Pb, Sb, Bi, Zn, Al, Ti, Co, Ni, Mn, Cd, and their mixtures; (c) Sodium- or potassium-containing oxides, carbides, nitrides, sulfides, phosphides, selenides, tellurides, or antimonides of Si, Ge, Sn, Pb, Sb, Bi, Zn, Al, Fe, Ti, Co, Ni, Mn, Cd, and mixtures or composites thereof; (d) Sodium or potassium salts; and (e) Graphene sheets pre-loaded or pre-attached with sodium ions (herein referred to as pre-sodiated graphene sheets).

The carbon or graphite material in the anode may be selected from those having an expanded inter-graphene planar spacing. For instance, meso-phase pitch, meso-phase carbon, meso carbon micro-beads (MCMB), coke particles, expanded graphite flakes, artificial graphite particles, natural graphite particles, highly oriented pyrolytic graphite, soft carbon particles, hard carbon particles, multi-walled carbon nanotubes, carbon nano-fibers, carbon fibers, graphite nano-fibers, graphite fibers, carbonized polymer fibers, or a combination thereof, wherein the carbon or graphite material has an inter-planar spacing d₀₀₂ from 0.27 nm to 0.42 nm prior to a chemical or physical expansion treatment and the inter-planar spacing d₀₀₂ is increased to from 0.43 nm to 3.0 nm after the expansion treatment.

In certain embodiments, the carbon or graphite material is selected from graphite foam or graphene foam having pores and pore walls, wherein the pore walls contain a stack of bonded graphene planes having an expanded inter-planar spacing d₀₀₂ from 0.45 nm to 1.5 nm. Preferably, the stack contains from 2 to 100 graphene planes.

In the disclosed rechargeable sodium-ion cell, the inter-planar spacing d₀₀₂ may be from 0.5 nm to 1.2 nm. Preferably, the inter-planar spacing d₀₀₂ is from 1.2 nm to 2.0 nm.

In some preferred embodiments, the expansion treatment may include an oxidation, fluorination, bromination, chlorination, nitrogenation, intercalation, combined oxidation-intercalation, combined fluorination-intercalation, combined bromination-intercalation, combined chlorination-intercalation, or combined nitrogenation-intercalation of the graphite or carbon material. These expansion treatments may be further followed by a constrained thermal expansion treatment to increase the d spacing from a more typical range of 0.5-1.2 nm to a range of 1.2-3.0 nm. The carbon or graphite material may contain a non-carbon element selected from oxygen, fluorine, chlorine, bromine, iodine, nitrogen, hydrogen, or boron.

There is no particular restriction on the type of cathode active material that can be implemented in the cathode of the presently disclosed sodium cell. In certain embodiments, the cathode comprises a cathode active material selected from NaFePO₄, Na₍₁₋ₓ₎KₓPO₄, KFePO₄, Na_{0.7}FePO₄, Na_{1.5}VOPO₄F_{0.5}, Na₃V₂(PO₄)₃, Na₃V₂(PO₄)₂F₃, Na₂FePO₄F, NaFeF₃, NaVPO₄F, KVPO₄F, Na₃V₂(PO₄)₂F₃, Na_{1.5}VOPO₄F_{0.5}, Na₃V₂(PO₄)₃, NaV₆O₁₅, NaₓVO₂, Na_{0.33}V₂O₅, NaₓCoO₂, Na_{2/3}[Ni_{1/3}Mn_{2/3}]O₂, Naₓ(Fe_{1/2}Mn_{1/2})O₂, NaₓMnO₂, λ-MnO₂, NaₓK₍₁₋ₓ₎MnO₂, Na_{0.44}MnO₂, Na_{0.44}MnO₂/C, Na₄Mn₉O₁₈, NaFe₂Mn(PO₄)₃, Na₂Ti₃O₇, Ni_{1/3}Mn_{1/3}Co_{1/3}O₂, Cu_{0.56}Ni_{0.44}HCF, NiHCF, NaₓMnO₂, NaCrO₂, KCrO₂, Na₃Ti₂(PO₄)₃, NiCo₂O₄, Ni₃S₂/FeS₂, Sb₂O₄, Na₄Fe(CN)₆/C, NaV₁₋ₓCrₓPO₄F, Se_{z}S_{y}, y/z=0.01 to 100, Se, sodium polysulfide, sulfur, Alluaudites, or a combination thereof, wherein x is from 0.1 to 1.0.

In some embodiments, the cathode comprises a cathode active material selected from a Na-based layered oxide (e.g., O3-type, P2-type, or P3-type), a polyanionic compound, a mixed polyanionic compound, a sulfate, a pyrophosphate, a Prussian Blue analog, or a combination thereof. In some specific embodiments, the cathode comprises a cathode active material selected from Na_{0.7}CoO₂, Na_{0.67}Ni_{0.25}Mg_{0.1}Mn_{0.65}O₂, Na_{0.5}[Ni_{0.23}Fe_{0.13}Mn_{0.63}]O₂, Na_{0.85}Li_{0.17}Ni_{0.21}Mn_{0.64}O₂, Zn doped Na_{0.833}[Li_{0.25}Mn_{0.75}]O₂, Na_{0.7}Mg_{0.05}[Mn_{0.6}Ni_{0.2}Mg_{0.15}]O₂, Na_{0.66}Co_{0.5}Mn_{0.5}O₂, Na_{2/3}Li_{1/9}Ni_{5/18}Mn_{2/3}O₂, C-coated NaCrO₂, Na_{0.9}[Cu_{0.22}Fe_{0.30}Mn_{0.48}]O₂, Na[Ni_{0.58}Co_{0.06}Mn_{0.36}]O₂, Na_{0.75}Ni_{0.82}Co_{0.12}Mn_{0.06}O₂, NaMn_{0.48}Ni_{0.2}Fe_{0.3}Mg_{0.02}O₂, V₂O₅ nanosheet, Na₃V₂(PO₄)₃, Na₃V₂(PO₄)₃/C, Na₃MnZr(PO₄)₃, Na₄Fe₃(PO₄)₂(P₂O₇), Na₃MnTi(PO₄)₃/C, carbon coated Na₃V₂(PO₄)₂F₃, Na₃(VOPO₄)₂F, graphene oxide protected Na₂₊₂ₓFe₂₋ₓ(SO₄)₃, Na_{2.3}Cu_{1.1}Mn₂O_{7-d}, graphene oxide protected Na₂FeP₂O₇, graphene oxide protected Na_{0.81}Fe[Fe(CN)₆]_{0.79-0.61}, Na₂CoFe(CN)₆, Ni_{0.67}Fe_{0.33}Se₂, or a combination thereof.

The working electrolyte may comprise a solvent selected from 1,3-dioxolane (DOL), 1,2-dimethoxyethane (DME), tetraethylene glycol dimethylether (TEGDME), poly(ethylene glycol) dimethyl ether (PEGDME), diethylene glycol dibutyl ether (DEGDBE), 2-ethoxyethyl ether (EEE), sulfone, sulfolane, ethylene carbonate (EC), dimethyl carbonate (DMC), methylethyl carbonate (MEC), diethyl carbonate (DEC), ethyl propionate, methyl propionate, propylene carbonate (PC), gamma-butyrolactone (γ-BL), acetonitrile (AN), ethyl acetate (EA), propyl formate (PF), methyl formate (MF), toluene, xylene, methyl acetate (MA), fluoroethylene carbonate (FEC), vinylene carbonate (VC), allyl ethyl carbonate (AEC), a hydrofluoroether, a room temperature ionic liquid solvent, or a combination thereof.

The electrolyte may further comprise an alkali metal salt selected from sodium perchlorate (NaClO₄), potassium perchlorate (KClO₄), sodium hexafluorophosphate (NaPF₆), potassium hexafluorophosphate (KPF₆), sodium borofluoride (NaBF₄), potassium borofluoride (KBF₄), sodium hexafluoroarsenide, potassium hexafluoroarsenide, sodium trifluoro-metasulfonate (NaCF₃SO₃), potassium trifluoro-metasulfonate (KCF₃SO₃), bis-trifluoromethyl sulfonylimide sodium (NaN(CF₃SO₂)₂), sodium trifluoromethanesulfonimide (NaTFSI), and bis-trifluoromethyl sulfonylimide potassium (KN(CF₃SO₂)₂), or a combination thereof. The content of aforementioned electrolytic salts in the non-aqueous solvent is preferably 0.5 to 3.0 M (mol/L) at the cathode side and 3.0 to >10 M at the anode side.

The ionic liquid is composed of ions only. Ionic liquids are low melting temperature salts that are in a molten or liquid state when above a desired temperature. For instance, a salt is considered as an ionic liquid if its melting point is below 100° C. If the melting temperature is equal to or lower than room temperature (25° C.), the salt is referred to as a room temperature ionic liquid (RTIL). The IL salts are characterized by weak interactions, due to the combination of a large cation and a charge-delocalized anion. This results in a low tendency to crystallize due to flexibility (anion) and asymmetry (cation).

A typical and well-known ionic liquid is formed by the combination of a 1-ethyl-3-methylimidazolium (EMI) cation and an N,N-bis(trifluoromethane)sulphonamide (TFSI) anion. This combination gives a fluid with an ionic conductivity comparable to many organic electrolyte solutions and a low decomposition propensity and low vapor pressure up to ˜300-400° C. This implies a generally low volatility and non-flammability and, hence, a much safer electrolyte for batteries.

Ionic liquids are basically composed of organic ions that come in an essentially unlimited number of structural variations owing to the preparation ease of a large variety of their components. Thus, various kinds of salts can be used to design the ionic liquid that has the desired properties for a given application. These include, among others, imidazolium, pyrrolidinium and quaternary ammonium salts as cations and bis(trifluoromethanesulphonyl) imide, bis(fluorosulphonyl)imide, and hexafluorophosphate as anions. Based on their compositions, ionic liquids come in different classes that basically include aprotic, protic and zwitterionic types, each one suitable for a specific application.

Common cations of room temperature ionic liquids (RTILs) include, but not limited to, tetraalkylammonium, di-, tri-, and tetra-alkylimidazolium, alkylpyridinium, dialkyl-pyrrolidinium, dialkylpiperidinium, tetraalkylphosphonium, and trialkylsulfonium. Common anions of RTILs include, but not limited to, BF₄⁻, B(CN)₄⁻, CH₃BF₃⁻, CH2CHBF₃⁻, CF₃BF₃⁻, C₂F₅BF₃⁻, n-C₃F₇BF₃⁻, n-C₄F₉BF₃⁻, PF₆⁻, CF₃CO₂⁻, CF₃SO₃⁻, N(SO₂CF₃)₂⁻, N(COCF₃)(SO₂CF₃)⁻, N(SO₂F)₂⁻, N(CN)₂⁻, C(CN)₃⁻, SCN⁻, SeCN⁻, CuCl₂⁻, AlCl₄⁻, F(HF)_{2.3}⁻, etc. Relatively speaking, the combination of imidazolium- or sulfonium-based cations and complex halide anions such as AlCl₄⁻, BF₄⁻, CF₃CO₂⁻, CF₃SO₃⁻, NTf₂⁻, N(SO₂F)₂⁻, or F(HF)_{2.3}⁻ results in RTILs with good working conductivities.

RTILs can possess archetypical properties such as high intrinsic ionic conductivity, high thermal stability, low volatility, low (practically zero) vapor pressure, non-flammability, the ability to remain liquid at a wide range of temperatures above and below room temperature, high polarity, high viscosity, and wide electrochemical windows. These properties, except for the high viscosity, are desirable attributes when it comes to using an RTIL as an electrolyte ingredient (a salt and/or a solvent) in a Na—S cell.

The present disclosure also provides a process for manufacturing the rechargeable sodium cell, the process comprising: (A) providing an anode comprising an anode current collector, or an anode current collector plus an active material layer wherein the anode active material layer is supported on a primary surface of the anode current collector; (B) providing a cathode comprising a cathode active material layer supported on a primary surface of an anode current collector; (C) depositing an elastic polymer electrolyte separator on the anode current collector (if no active material layer is present), the anode active material layer, or the cathode active material layer; (D) combining the anode, the elastic polymer electrolyte separator, and the cathode to form a cell wherein the elastic polymer electrolyte separator is disposed between the anode and the cathode; and (E) encasing the cell in a protective housing to form the rechargeable sodium cell.

In some embodiments, step (C) comprises (a) providing (i) a liquid polymer solution comprising a high-elasticity polymer dissolved in a liquid solvent or (ii) a liquid reactive mass (e.g., a monomer and initiator or an oligomer and a crosslinking agent, etc.) as a precursor to a high-elasticity polymer; (b) dispensing and depositing a layer of the liquid solution or the liquid reactive mass onto a solid substrate surface, wherein the solid substrate is the anode current collector, the anode active material layer, or the cathode active material layer; and (c) removing the liquid solvent from the liquid polymer solution to precipitate out the high-elasticity polymer or polymerizing and/or curing the reactive mass to form the layer of high-elasticity polymer separator.

The liquid polymer solution or the liquid reactive mass may comprise a sodium salt and/or a sodium ion-conducting material dissolved or dispersed therein.

The process may be practiced as a roll-to-roll process wherein step (b) comprises (1) continuously feeding a layer of the solid substrate from a feeder roller to a dispensing zone where the liquid polymer solution or the reactive mass is dispensed and deposited onto the solid substrate to form a continuous layer of the liquid polymer solution or the reactive mass; and (2) moving the layer of the liquid polymer solution or the reactive mass into a reacting zone where the liquid polymer solution or the reactive mass is subjected to solvent removal or exposed to heat, ultraviolet light, or high-energy radiation to polymerize and/or cure the reactive mass to form a continuous layer of elastic polymer supported on the solid substrate.

In some embodiments, the solid substrate comprises an anode current collector or an anode active material layer supported on an anode current collector and the process further comprises continuously feeding a cathode active material layer (supported on a cathode current collector) and covering the elastic polymer layer with the cathode active material layer to form a multi-layer structure, which is optionally wound and collected on a winding roller.

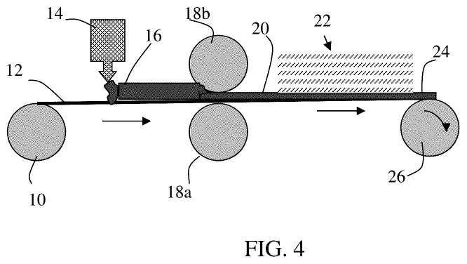

In certain embodiments, as illustrated in FIG. 4, the roll-to-roll process may begin with continuously feeding a solid substrate layer 12 (e.g., PET film) from a feeder roller 10. A dispensing device 14 is operated to dispense and deposit a reactive mass 16 (e.g., slurry) onto the solid substrate layer 12, which is driven toward a pair of rollers (18a, 18b). These rollers are an example of a provision to regulate or control the thickness of the reactive mass 20. The reactive mass 20, supported on the solid substrate, is driven to move through a reacting zone 22 which is provided with a curing means (heat, UV, high energy radiation, etc.). The partially or fully cured polymer 24 is collected on a winding roller 26. One may unwind the roll at a later stage.

The following examples are presented primarily for the purpose of illustrating the best mode practice of the present invention and should not be construed as limiting the scope of the present invention.

### EXAMPLE 1

### Anode-Less Sodium Metal Battery (Initially Sodium-Free in the Anode) Containing a High-Elasticity Polymer Separator

For the preparation of a high-elasticity polymer separator, the ethoxylated trimethylopropane triacrylate monomer (ETPTA, Mw=428, Sigma-Aldrich) was dissolved in a solvent mixture of ethylene carbonate (EC)/diethyl carbonate (DEC), at a weight-based composition ratio of the ETPTA/solvent of 3/97 (w/w). Subsequently, benzoyl peroxide (BPO, 1.0 wt. % relative to the ETPTA content) as a radical initiator, along with a desired amount of selected sodium salt (e.g., sodium hexafluorophosphate, NaPF₆, or sodium borofluoride, NaBF₄), were added to allow for thermal crosslinking reaction upon deposition on a Cu foil surface. This layer of ETPTA monomer/initiator was then thermally cured at 60° C. for 30 min to obtain an elastomer separator layer.

On a separate basis, some amount of the ETPTA monomer/solvent/initiator solution was cast onto a glass surface to form a wet film, which was thermally dried and then cured at 60° C. for 30 min to form a film of cross-linked polymer. In this experiment, the BPO/ETPTA weight ratio was varied from 0.1% to 4% to vary the degree of cross-linking in several different polymer films. Some of the cured polymer samples were subjected to dynamic mechanical testing to obtain the equilibrium dynamic modulus, Ge, for the determination of the number average molecular weight between two cross-link points (Mc) and the corresponding number of repeat units (Nc), as a means of characterizing the degree of cross-linking. The typical and preferred number of repeat units (Nc) is from 5 to 5,000, more preferably from 10 to 1,000, further preferably from 20 to 500, and most preferably from 50 to 500.

Several tensile testing specimens were cut from each cross-link film and tested with a universal testing machine. The testing results indicate that BPO-initiated cross-linked ETPTA polymers have an elastic deformation from approximately 230% to 700%. The above values are for neat polymers without any additive. The addition of up to 30% by weight of an inorganic filler typically reduces this elasticity down to a reversible tensile strain in the range of 10% to 120%.

The cathode active materials used in the present example include Na₄Fe₃(PO₄)₂(P₂O₇) particles. Both nano-sized Na₄Fe₃(PO₄)₂(P₂O₇) plates (NFPP-E) and microporous Na₄Fe₃(PO₄)₂(P₂O₇) particles (NFPP-C) were prepared via well-known sol-gel methods. In a representative process, 4 mmol sodium acetate, 4 mmol ammonium phosphate, 0.1 g glucose, and 0.1 g stearic acid were added to 20 ml deionized water with stirring until a transparent solution was obtained (denoted as solution A). Then, 3 mmol iron (II) acetate, 0.8768 g ethylene-diamine-tetraacetic acid, and 0.05 g cetyltrimethyl ammonium bromide were added to 20 ml deionized water with stirring until a transparent solution was obtained (denoted as solution B). Subsequently, solution B was added dropwise to solution A with vigorous stirring. The mixed solution was then heated in a water bath at 90° C. until all the excess water was removed and the sol-gel precursor was obtained. The precursor was ground into a fine powder and then annealed at 500° C. for 24 h under high-purity Ar gas atmosphere with an intermediate grinding. The final nano-sized Na₄Fe₃(PO₄)₂(P₂O₇) plates were herein denoted as NFPP-E. For the microporous Na₄Fe₃(PO₄)₂(P₂O₇) particles, all the preparation procedures were the same, except that 0.6305 g citric acid monohydrate was used to replace the 0.8768 g ethylene-diamine-tetraacetic acid in solution B. The final product was herein denoted as NFPP-C. Both the final NFPP-E and NFPP-C samples were transferred into an Ar-filled glove box after annealing until further use.

For electrochemical testing, the working electrodes (cathode layers) were prepared by mixing 85 wt. % of Na₄Fe₃(PO₄)₂(P₂O₇) plates or particles, 5-8 wt. % CNTs, and 7 wt. % polyvinylidene fluoride (PVDF) binder dissolved in N-methyl-2-pyrrolidinoe (NMP) to form a slurry of 5 wt. % total solid content. After coating the slurries on Al foil, the electrodes were dried at 120° C. in vacuum for 2 h to remove the solvent before pressing. Then, the electrodes were cut into a disk (ϕ=12 mm) and dried at 100° C. for 24 h in vacuum.

Electrochemical measurements were carried out using CR2032 (3V) coin-type cells with a sheet of Cu foil as an anode current collector (initially having no sodium metal as the anode active material), an elastic composite separator, and 1 M NaPF₆ electrolyte solution dissolved in a mixture of ethylene carbonate (EC) and diethyl carbonate (DEC) (EC-DEC, 1:1 v/v) to serve as a working electrode. Another similarly configured cell was prepared, but using a conventional porous PE/PP separator. The cell assembly was performed in an argon-filled glove-box. The CV measurements were carried out using an electrochemical workstation at a scanning rate of 1 mV/s. The electrochemical performance of the cell featuring high-elasticity polymer separator and that containing a conventional plastic separator were evaluated by galvanostatic charge/discharge cycling at a current density of 50 mA/g using an Arbin electrochemical workstation.

The specific intercalation capacity curves of two sodium cells were measured. As the number of cycles increases, the specific capacity of the cell with a conventional plastic separator drops at a fast rate. In contrast, the presently invented lightly cross-linked ETPTA polymer separator provides the battery cell with a significantly more stable and high specific capacity for a large number of cycles. These data have clearly demonstrated the surprising and superior performance of the presently invented cross-linked ETPTA polymer composite separator approach.

The high-elasticity cross-linked ETPTA polymer separator layer appears to be capable of reversibly deforming to a great extent without breakage when the sodium foil decreases in thickness during battery discharge. The elastic polymer separator layer also prevents the continued reaction between liquid electrolyte and sodium metal at the anode, reducing the problem of continuing sodium and electrolyte losses. This also enables a significantly more uniform deposition of sodium ions upon returning from the cathode during a battery re-charge; hence, no sodium dendrite. These were observed by using SEM to examine the surfaces of the electrodes recovered from the battery cells after some numbers of charge-discharge cycles.

### EXAMPLE 2

### High-Elasticity Polymer Layer Implemented as the Separator of a Sodium Cell (the Cell Being Initially Sodium-Free) Having Na₃(VOPO₄)₂F (NVPOF) as a Cathode Active Material

For use as a cathode active material, the family of compounds, Na₃(VOPO₄)₂F (NVPOF) with a lower F content, were synthesized according to a procedure summarized below: Sodium metavanadate (NaVO₃, ≥99%), sodium dihydrogen phosphate dihydrate (NaH₂PO₄.2H₂O, ≥99%), and sodium fluoride (NaF, ≥98%) were employed as vanadium, phosphorus, and fluorine resources, respectively, to synthesize NVPOF. Hydroxylamine (HONH₂.HCl) was used as a reductive agent. In a typical synthesis procedure for multi-shelled hollow NVPOF micro-spheres, 350 mL of 6 mol·L⁻¹ HONH₂.HCl was added into 700 mL of 1 mol·L⁻¹ NaVO₃. Then, H₂SO₄ was used to adjust pH to 3.5 to obtain a homogeneous transparent solution A. 175 g of NaH₂PO₄ and 25.9 g of NaF were dissolved in the deionized water to obtain another solution, B. Finally, solution B was slowly added into the solution A under strong stirring. After stirring stopped, a light-blue precipitate started to appear after a few minutes. The reaction mixture was allowed to stand for some time. The obtained light-blue precipitate was washed with distilled water and dried at 110° C. in a vacuum overnight. This resulted in approximately 150 g of NVPOF powder with a yield of around 100%.

The high-elasticity polymer for making an elastic polymer separator was based on cationic polymerization and cross-linking of the cyanoethyl polyvinyl alcohol (PVA-CN) in succinonitrile (SN). The procedure began with dissolving PVA-CN in succinonitrile to form a mixture solution. This step was followed by adding an initiator into the solution. For the purpose of incorporating some sodium species into the high elasticity polymer, we chose to use NaPF₆ as an initiator. The ratio between NaPF₆ and the PVA-CN/SN mixture solution was varied from 1/20 to 1/2 by weight to form a series of precursor solutions. Subsequently, these solutions were separately spray-deposited to form a thin layer of precursor reactive mass onto a Cu foil. The precursor reactive mass was then heated at a temperature from 75 to 100° C. for 2 to 8 hours to obtain a layer of high-elasticity polymer adhered to the Cu foil surface. A cathode layer supported by an Al foil was then brought to cover the polymer layer to form a cell. Electrochemical testing results show that the cell having an elastic polymer separator layer offers a significantly more stable cycling behavior.

Additionally, some amount of the reacting mass, PVA-CN/NaPF₆, was cast onto a glass surface to form several films which were polymerized and cross-linked to obtain cross-linked polymers having different degrees of cross-linking. Tensile testing was also conducted on these films and this series of cross-linked polymers can be elastically stretched up to approximately 80%.

### EXAMPLE 3

### Sodium Cells Containing a PETEA-Based High-Elasticity Polymer-Protected Anode and sodium-Vanadium Fluorophosphates-Based Cathode

For preparing as an elastic composite separator layer, pentaerythritol tetra-acrylate (PETEA), Formula 3, was used as a monomer:

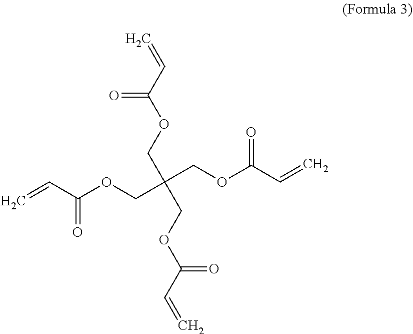 [SMILES: C=CC(=O)OCC(COC(=O)C=C)(COC(=O)C=C)COC(=O)C=C]

In a representative procedure, the precursor solution was composed of 1.5 wt. % PETEA (C₁₇H₂₀O₈) monomer and 0.1 wt. % azodiisobutyronitrile (AIBN, C₈H₁₂N₄) initiator dissolved in a solvent mixture of 1,2-dioxolane (DOL)/dimethoxymethane (DME)(1:1 by volume). The PETEA/AIBN precursor solution, along with a sodium salt (such as sodium borofluoride and NaF) dispersed therein, was cast onto a sodium metal layer pre-deposited on a Cu foil surface to form a precursor film, which was polymerized and cured at 70° C. for half an hour to obtain a lightly cross-linked polymer. This polymer layer was then covered with a cathode electrode.

The sodium-vanadium fluorophosphates powder, along with graphene sheets (as a conductive additive), was then added into an NMP and PVDF binder suspension to form a multiple-component slurry. The slurry was then slurry-coated on Al foil to form cathode layers.

The powder of sodium-vanadium fluorophosphates, Na_{1+y}VPO₄F_{1+y} (0≤y≤0.75), were prepared by the two-step solid-state method, according to the following reactions, using VPO₄ as an intermediate:

1/2V₂O₅+NH₄H₂PO₄+C→VPO₄+NH₃+3/2H₂O+CO (1)

VPO₄+(1+y)NaF→Na_{1+y}VPO₄F_{1+y} (2)

The preliminary solid-state mechanical activation (MA) of both reagent mixtures was performed by means of a high-energy 2 planetary mill (˜900 rpm), with stainless jars and balls in Ar atmosphere for 5 min. The activated mixtures (1) and (2) were subsequently annealed in Ar flow for 2 h at 750° C. and 650° C., respectively, and then slowly cooled to room temperature.

Two types of anodes were used: a layer of hard carbon particles (along with 5% carbon nano-fibers as a conductive additive and SBR as a binder) coated on a Cu foil and Cu foil alone (without any Na initially).

The discharge capacity curves were obtained on two coin cells having the same cathode active material, but one cell having an elastic polymer separator and the other having a conventional porous plastic separator. These results have demonstrated that the elastic polymer separator strategy provides excellent protection against capacity decay of a sodium metal battery. The high-elasticity polymer separator appears to be capable of reversibly deforming without breakage and maintaining good contacts with the anode when the sodium metal layer expands and shrinks during charge and discharge.

Additionally, the reacting mass, PETEA/AIBN (without any additive), was cast onto a glass surface to form several films that were polymerized and cured to obtain cross-linked polymers having different degrees of cross-linking. Tensile testing was also conducted on these films and this series of cross-linked polymers can be elastically stretched up to approximately 25% (higher degree of cross-linking) to 80% (lower degree of cross-linking).

### EXAMPLE 4

### Na Metal Cells Containing a Sulfonated Triblock Copolymer, poly(styrene-isobutylene-styrene) or SIBS, as an Elastic Polymer Separator

Both non-sulfonated and sulfonated elastomer composites were used to build an elastic polymer separator in the anode-less sodium cells. The sulfonated versions typically provide a much higher sodium ion conductivity and, hence, enable higher-rate capability or higher power density. The elastomer matrix can contain a sodium ion-conducting additive, if so desired. An example of the sulfonation procedure used in this study for making a sulfonated elastomer is summarized as follows: a 10% (w/v) solution of SIBS (50 g) in methylene chloride (500 ml) was prepared. The solution was stirred and refluxed at approximately 40° C., while a specified amount of acetyl sulfate in methylene chloride was slowly added to begin the sulfonation reaction. Acetyl sulfate in methylene chloride was prepared prior to this reaction by cooling 150 ml of methylene chloride in an ice bath for approximately 10 min. A specified amount of acetic anhydride and sulfuric acid was then added to the chilled methylene chloride under stirring conditions. Sulfuric acid was added approximately 10 min after the addition of acetic anhydride with acetic anhydride in excess of a 1:1 mole ratio. This solution was then allowed to return to room temperature before addition to the reaction vessel.

After approximately 5 h, the reaction was terminated by slowly adding 100 ml of methanol. The reacted polymer solution was then precipitated with deionized water. The precipitate was washed several times with water and methanol, separately, and then dried in a vacuum oven at 50° C. for 24 h. This washing and drying procedure was repeated until the pH of the wash water was neutral. After this process, the final polymer yield was approximately 98% on average. This sulfonation procedure was repeated with different amounts of acetyl sulfate to produce several sulfonated polymers with various levels of sulfonation or ion-exchange capacities (IECs). The mol % sulfonation is defined as: mol %=(moles of sulfonic acid/moles of styrene)×100%, and the IEC is defined as the mille-equivalents of sulfonic acid per gram of polymer (mequiv./g).

After sulfonation and washing of each polymer, the S-SIBS samples were dissolved in a mixed solvent of toluene/hexanol (85/15, w/w) with concentrations ranging from 0.5 to 2.5% (w/v). The solution samples were spray-coated on a PET plastic substrate to form free-standing layers of sulfonated elastomer. A layer of elastomer was then sandwich between a sodium metal anode (or just a Cu foil) and a cathode electrode.

### EXAMPLE 5

### Elastic Polyurethane Elastomer-Based Solid Electrolyte Separator

Twenty-four parts by weight of diphenylmethane diisocyanate and 22 parts by weight of butylene glycol were continuously reacted with 100 parts by weight of polyethylene adipate having hydroxyl groups at both terminals (molecular weight of 2,100) with agitation at a reaction temperature of 115° C. (along with approximately 32% by weight of NaF and NaTFSI) for a reaction time of 60 minutes to give a prepolymer having hydroxyl-terminal. This prepolymer having hydroxyl-terminal had a viscosity of 4,000 cP at 70° C.

On a separate basis, 84 parts by weight of diphenylmethane diisocyanate was continuously reacted with 200 parts by weight of polyethylene adipate haying hydroxyl groups at both terminals (molecular weight of 2,100) with agitation at a reaction temperature of 115° C. for a reaction time of 60 minutes to give a prepolymer having isocyanate-terminal. This prepolymer having isocyanate-terminal had a viscosity of 1,500 cP at 70° C.

One hundred forty-six (146) parts by weight of the thus obtained prepolymer having hydroxyl-terminal and 284 parts by weight of the obtained prepolymer having isocyanate-terminal were continuously injected into a heat exchange reactor and mixed and stirred at a reaction temperature of 190° C. for a residence time of 5-30 minutes. The obtained viscous product was immediately cast onto a glass surface to obtain a layer of elastic polymer having a thickness of approximately 4.1, 12.2, and 20 μm, respectively.

On a separate basis, a sample of reactive polysiloxane (mixed with 5% by wt. of NaF and 5% Na₂CO₃) was cast onto an anode surface and cured at 115° C. bar 2 hours to form an elastic polymer film of 8-45 μm in thickness. The sodium ion conductivity of these thin films was approximately 1.2-33 10⁻⁵ S/cm.

### EXAMPLE 6

### Polyisoprene Elastomer-Based Solid Electrolyte Separator Layer

A dilute elastomer-solvent solution (0.01-0.1 M of cis-polyisoprene in cyclohexane and 1,4-dioxane) was prepared as a coating solution. Subsequently, sodium hexafluoro phosphate, as a sodium salt, was added and dissolved in the above solution. The solution was then cast over an anode current collector, followed by solvent vaporization to obtain an elastomer-coated anode electrode. A sodium-ion cell was made, comprising the solid-state polymer electrolyte separator-covered anode active layer of NaTi₂(PO₄)₃ coated on a Cu foil, a cathode (comprising 75% by weight of Prussian Blue analog/NaCoO₂ (1/1 mixture)as the cathode active material, 15% of hybrid particulates, 5% PVDF binder, and 5% combined graphene/CNT as a conductive additive).

### EXAMPLE 7

### Sulfonated Polybutadiene (PB) Elastomer Separator

Sulfonated PB may be obtained by free radical addition of thiolacetic acid (TAA) followed by in Situ oxidation with performic acid. A representative procedure is given as follows. PB (8.0 g) was dissolved in toluene (800 mL) under vigorous stirring for 72 h at room temperature in a 1 L round-bottom flask. Benzophenone (BZP) (0.225 g; 1.23 mmol; BZP/olefin molar ratio=1:120) and TAA (11.9 mL; 0.163 mol, TAA/olefin molar ratio =1.1) were introduced into the reactor and the polymer solution was irradiated for 1 h at room temperature with UV light of 365 nm and power of 100 W.

The resulting thio-acetylated polybutadiene (PB-TA) was isolated by pouring 200 mL of the toluene solution in a plenty of methanol and the polymer recovered by filtration, washed with fresh methanol, and dried in vacuum at room temperature. Formic acid (117 mL; 3.06 mol; HCOOH/olefin molar ratio=25), along with a desired amount (0.1%-40% by wt.) of sodium salt (NaPF₆ and sodium trifluoromethanesulfonimide or NaTFSI, respectively), were added to the toluene solution of PB-TA at 50° C. followed by slow addition of 52.6 mL of hydrogen peroxide (35 wt %; 0.61 mol; H₂O₂/olefin molar ratio=5) in 20 min. We would like to caution that the reaction is autocatalytic and strongly exothermic. The resulting solution was coated onto an anode layer (40% hard carbon particles+35% Si particles+10% CMC binder+15% graphene sheets) to obtain sulfonated polybutadiene separator-covered anode electrode.

### EXAMPLE 8

### Poly(butyl acrylate) Rubber Containing dinitrile/NaTFSI-Based Plastic Crystals Dispersed Therein

For polymerization of PBA rubber, azobisisobutyronitrile (AIBN; 0.5 mol %) and poly(ethylene glycol) diacrylate (PEGDA; 1 mol %) were used as the thermal initiator and cross-linking agent, respectively. In this butyl acrylate (BA) polymerization process, BA/PEGDA produces polymers chemically cross-linked by PEGDA, eventually resulting in elastomer networks. Dinitrile (AND, GLN, and SEN, respectively), in combination with a sodium salt (e.g., NaTFSI and/or NaNO₃), were used to form plastic crystal domains, where the chemical structures of these dinitriles are given below:

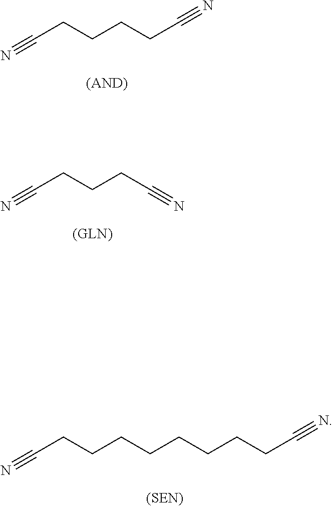 [SMILES: N#CCCCCC#N ; N#CCCCC#N ; N#CCCCCCCCCC#N]

The BA-based solutions were prepared by dissolving 1 mol % PEGDA, 0.5 mol % AIBN, and 1 M NaTFSI/NaNO₃ powder in BA liquid. The BA-based solutions were polymerized at 70° C. for 2 h to obtain BA-based elastomer with plastic crystal domains dispersed therein. The dinitrile-based solutions were made by mixing a dinitrile with 1 M NaTFSI/NaNO₃ powder and 5 vol % fluoroethylene carbonate additive at 60° C. to protect against the potential side reaction of dinitrile with Na metal. The two prepared liquid solutions were homogeneously mixed in a volume ratio of 1:1 at 50° C. to produce the elastomer. After dispensing and depositing the prepared solution onto a surface of a cathode active material layer supported on an Al foil current collector, the reactive mass was heated at 70° C. for 2 h to obtain the elastomer layer that was substantially well-bonded to the cathode active layer. For the preparation of an anode-less sodium metal cell, a Cu foil was then covered onto this elastomer layer. For the preparation of a conventional sodium metal cell, the elastomer layer was then covered with a layer of sodium metal foil (20 μm in thickness), which was in turn covered by a Cu foil. The resulting multi-layer structures were then roll-pressed to produce sodium metal cells. In this study, the cathode active layers were prepared from carbon-coated Na_{0.44}MnO₂ and Prussian Blue as cathode active materials, respectively.

### EXAMPLE 9

### Poly(butyl acrylate) Rubber Containing Combined sodium bis(oxalato)borate (NaBOB)/DMMP, DMMEMP, and phosphazene-Based ion-Conducting Domains

Substantially the same procedure as described in Example 8 was followed, but using sodium bis(oxalato)borate (LiBOB)/DMMP, DMMEMP, and phosphazene as the sodium ion-conducting organic species:

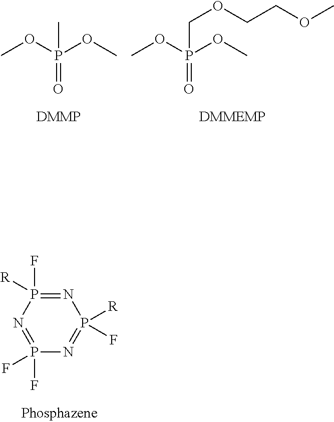

wherein R═H. The sodium ion conductivity of this group of elastic polymer separator layers was found to be from 0.12×10⁻³ to 0.9×10⁻³ S/cm.

### EXAMPLE 10

### Acrylate Rubber-Based Solid-State Electrolyte Separator

A mixture of monomers was prepared in a first vessel equipped with an agitator. The mixture contained 96 parts of ethyl acrylate, 1 part of methacrylic acid, 3 parts of vinyl chloroacetate and 0.01 parts of t-dodecyl mercaptan. In a second vessel, an emulsifying mixture was prepared containing 275 parts of demineralized water preheated at 70° C., 3.2 parts of sodium lauryl sulfate, 1.1 parts of a polymeric condensate of β-naphthalene sulphonic acid and 0.7 parts of sodium bicarbonate. In a third vessel, an initiator solution was prepared with 70 parts of water and 0.45 parts of potassium persulfate.

A polymerization reactor was repeatedly, filled and purged with nitrogen gas for the purpose of eliminating any trace of oxygen. The pre-heated emulsifying mixture was then fed into the reactor, which was followed by the addition of 60% of the initiator hatch. The reactor temperature was adjusted to 50° C. and the continuous and uniform feeding of the reaction mixture (monomers mixed with the chain transfer agent) started, drop by drop, during a period of six hours. During the third hour of the reaction, the remaining 40% of the initiator solution was added. When the mixture was totally consumed, the reaction was completed. After the end of the reaction, the rubber latex or the acrylic elastomer was coagulated by the addition of excessive calcium chloride. The rubber was washed and dried at around 65° C.

Solvents that can be used to dissolve the polyacrylic latex include methylethyl ketone, toluene, xylene, or benzene.

In conclusion, the high-elasticity polymer-based separator strategy is surprisingly effective in alleviating the problems of sodium metal dendrite formation and sodium metal-electrolyte reactions that otherwise lead to rapid capacity decay and potentially internal shorting and explosion of the sodium secondary batteries. The high-elasticity polymer composite is capable of expanding or shrinking congruently or conformably with the anode layer. This capability helps to maintain a good contact between the current collector (or the deposited sodium film during the charging procedure) and the separator, enabling uniform re-deposition of sodium ions without interruption.

1. A rechargeable sodium cell, comprising an anode, a cathode, and an elastic polymer electrolyte separator disposed between said cathode and said anode, wherein said elastic polymer electrolyte separator has a thickness from 10 nm to 200 μm and comprises a high-elasticity polymer having a sodium ion conductivity from 10⁻⁸ S/cm to 5×10⁻² S/cm at room temperature and a fully recoverable tensile strain from 2% to 1,000% when measured without any additive dispersed therein.

2. The rechargeable sodium cell of claim 1, which is a sodium metal cell wherein the anode has an anode current collector but initially the anode has no sodium or sodium alloy as an anode active material supported by said anode current collector when the battery cell is made and prior to a charge or discharge operation of the battery.

3. The rechargeable sodium cell of claim 1, which is a sodium metal cell wherein the anode has an anode current collector and an amount of sodium or sodium alloy as an anode active material supported by said anode current collector.

4. The rechargeable sodium cell of claim 1, wherein said high-elasticity polymer comprises an elastomer or rubber selected from natural polyisoprene, synthetic polyisoprene, polybutadiene, chloroprene rubber, polychloroprene, butyl rubber, poly(butyl diacrylate), styrene-butadiene rubber, nitrile rubber, ethylene propylene rubber, ethylene propylene diene rubber, metallocene-based poly(ethylene-co-oetene) elastomer, polytethylene-co-butene) elastomer, styrene-ethylene-butadiene-styrene elastomer, epichlorohydrin rubber, polyacrylic rubber, silicone rubber, fluorosilicone rubber, perfluoroelastomers, polyether block amides, chlorosulfonated polyethylene, ethylene-vinyl acetate, thermoplastic elastomer, protein resilin, protein elastin, ethylene oxide-epichlorohydrin copolymer, polysiloxane, poly(alkyl siloxane), polyurethane, urethane-urea copolymer, urethane-acrylic copolymer, a copolymer thereof, a sulfonated version thereof, or a combination thereof.

5. The rechargeable sodium cell of claim 1, wherein the high-elasticity polymer contains a lightly cross-linked network of polymer chains having an ether linkage, nitrile-derived linkage, benzo peroxide-derived linkage, ethylene oxide or ethylene glycol linkage, propylene oxide linkage, vinyl alcohol linkage, cyano-resin linkage, triacrylate monomer-derived linkage, tetraacrylate monomer-derived linkage, a derivative thereof, or a combination thereof, and the cross-linked network of polymer chains has a degree of crosslinking that affords an elasticity of the polymer in the range from 5% to 1,000%.

6. The rechargeable sodium cell of claim 1, wherein said elastic polymer separator further comprises from 0.1% to 70% by weight of a sodium ion-conducting material dispersed or dissolved in the high-elasticity polymer.

7. The rechargeable sodium cell of claim 6, wherein said sodium ion-conducting material comprises a sodium salt selected from sodium perchlorate (NaClO₄), sodium chlorate (NaClO₃), sodium hexafluorophosphate (NaPF₆), sodium borofluoride (NaBF₄), sodium hexafluoroarsenide, sodium trifluoro-metasulfonate (NaCF₃SO₃), bis-trifluoromethyl sulfonylimide sodium (NaN(CF₃SO₂)₂), sodium trifluoromethanesulfonimide (NaTFSI), sodium bis(fluoroallyl)malonato borate salt (NaBFMB), sodium poly(tartaric acid)borate (NaPTAB) salt, NaCF₃COO, Na₂CO₃, Na₂O, Na₂C₂O₄, NaOH, NaX, ROCO₂Na, HCONa, RONa, (ROCO₂Na)₂, (CH₂OCO₂Na)₂, Na₂S, NaₓSO_{y}, wherein X═F, Cl, I, or Br, R=a hydrocarbon group, x=0-1, y=1-4, or a combination thereof.

8. The rechargeable sodium cell of claim 6, wherein said sodium ion-conducting material comprises an inorganic solid electrolyte material having a sodium ion conductivity no less than 10⁻⁸ S/cm.

9. The rechargeable sodium cell of claim 1, wherein the high-elasticity polymer forms a mixture, blend, copolymer, crosslinked network, or interpenetrating network with a sodium ion-conducting polymer selected from poly(ethylene oxide) (PEO), Polypropylene oxide (PPO), polyethylene glycol (PEG), polyvinyl alcohol (PVA), poly(vinyl pyrrolidone) (PVP), poly(ethyl methacrylate) (PEMA), poly(acrylonitrile) (PAN), poly(methyl methacrylate) (PMMA), poly(vinylidene fluoride) (PVdF), Poly bis-methoxy ethoxyethoxide-phosphazenex, Polyvinyl chloride, Polydimethylsiloxane, poly(vinylidene fluoride)-hexafluoropropylene (PVDF-HFP), a sulfonated derivative thereof, or a combination thereof.

10. The rechargeable sodium cell of claim 1, wherein the high-elasticity polymer comprises from 5% to 95% by weight of a lithium ion-conducting plastic crystal or organic plasticizer dispersed in or connected to the high-elasticity polymer

11. The rechargeable sodium cell of claim 10, wherein the high-elasticity polymer and the plastic crystal or organic plasticizer form co-continuous phases exhibiting a sodium-ion conductivity no less than 10⁻⁵ S/cm.

12. The rechargeable sodium cell of claim 10, wherein the plastic crystal or organic plasticizer comprises a mixture of a sodium salt and a sodium ion-conducting organic species selected from a fluorinated carbonate, hydrofluoroether, fluorinated vinyl carbonate, fluorinated ester, fluorinated vinyl ester, fluorinated vinyl ether, sulfone, sulfide, nitrile, phosphate. phosphite, phosphonate, sulfate, siloxane, silane, 1,3-dioxolane (DOL), 1,2-dimethoxyethane (DME), tetraethylene glycol dimethylether (TEGDME), poly(ethylene glycol) dimethyl ether (PEGDME), diethylene glycol dibutyl ether (DEGDBE), 2-ethoxyethyl ether (EEE), sulfolane, acetonitrile (AN), acrylonitrile, succinoniitrile, fluoroethylene carbonate (FEC), an ionic liquid solvent, a polymerized version thereof, or a combination thereof.

13. The rechargeable sodium cell of claim 1, wherein the polymerized version of the organic species has a molecular weight less than 10,000 g/mole. 15 14. The rechargeable sodium cell of claim 12, wherein the sulfone or sulfide is selected from vinyl sulfone, allyl sulfone, alkyl vinyl sulfone, aryl vinyl sulfone, vinyl sulfide, a vinyl-containing variant of TrMS, MTrMS, TMS, EMS, MMES, EMES, EMEES, or a combination thereof:

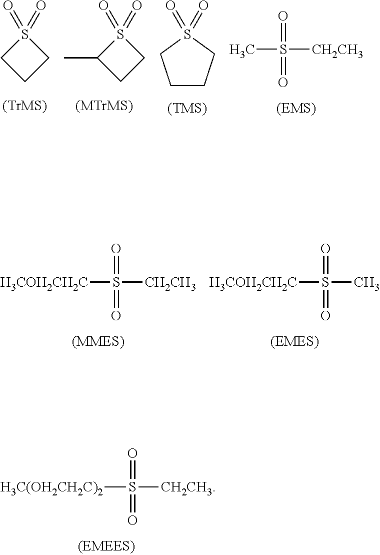

15. The rechargeable sodium cell of claim 12, wherein the vinyl sulfone or sulfide is selected from ethyl vinyl sulfide, allyl methyl sulfide, phenyl vinyl sulfide, phenyl vinyl sulfoxide, allyl phenyl sulfone, allyl methyl sulfone, divinyl sulfone, or a combination thereof, wherein the vinyl sulfone does not include methyl ethylene sulfone and ethyl vinyl sulfone.

16. The rechargeable sodium cell of claim 12, wherein the nitrile comprises a dinitrile or is selected from AND, GLN, SEN, succino-nitrile, or a combination thereof, wherein AND, GLN, and SEM have the following formula:

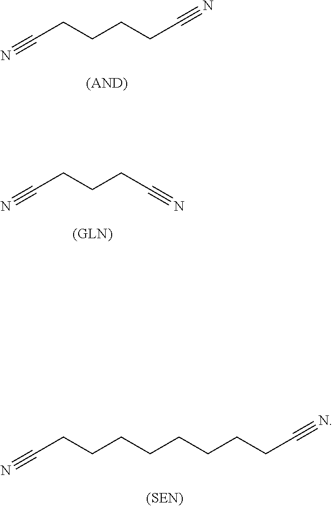 [SMILES: N#CCCCCC#N ; N#CCCCC#N ; N#CCCCCCCCCC#N]

17. The rechargeable sodium cell of claim 12, wherein the phosphate is selected from allyl-type, vinyl-type, styrenic-type and (meth)acrylic-type monomers bearing a phosphonate moiety.

18. The rechargeable sodium cell of claim 12, wherein the phosphate, phosphonate, phosphonic acid, phosphazene, or phosphite is selected from TMP, TEP, TFP, TDP, DPOF, DMMP, DMMEMP, tris(trimethylsilyl)phosphite (TTSPi), alkyl phosphate, triallyl phosphate (TAP), a combination thereof, wherein TMP, TEP, TFP, TDP, DPOF, DMMP, DMMEMP, and phosphazene have the following chemical formulae: 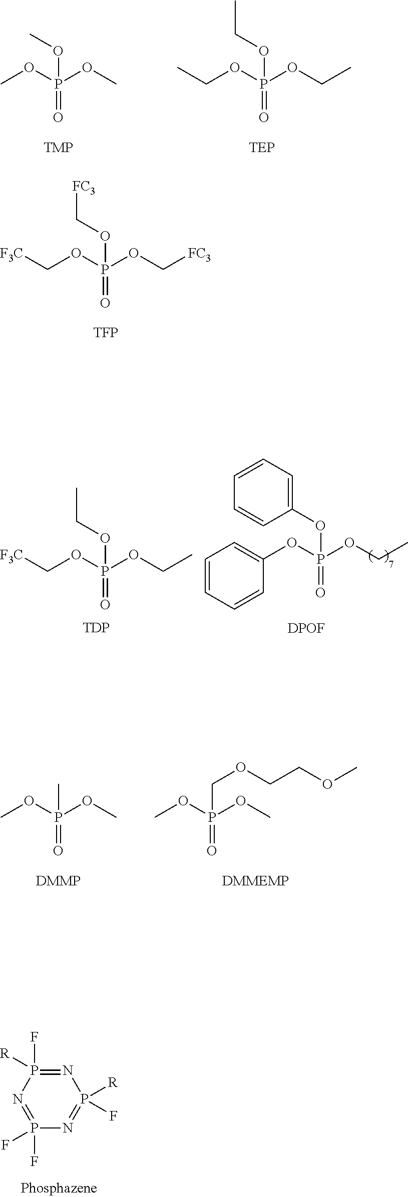
wherein R═H, NH₂, or C₁-C₆ alkyl.

19. The rechargeable sodium cell of claim 12, wherein the silaxane or silane is selected from alkylsiloxane (Si—O), alkyylsilane (Si—C), liquid oligomeric silaxane (—Si—O—Si—), or a combination thereof.

20. The rechargeable sodium cell of claim 1, wherein the high-elasticity polymer further contains a reinforcement material dispersed therein wherein the reinforcement material is selected from a polymer fiber, a glass fiber, a ceramic fiber, a nano-flake, or a combination thereof.

21. The rechargeable sodium cell of claim 1, wherein said battery further comprises, in addition to the elastic polymer separator serving as a solid electrolyte, a working electrolyte in ionic contact with an anode active material and/or a cathode active material wherein said working electrolyte is selected from an organic liquid electrolyte, ionic liquid electrolyte, polymer gel electrolyte, solid polymer electrolyte identical to or different than the high-elasticity polymer in composition or structure, inorganic solid electrolyte, or a quasi-solid electrolyte having a sodium salt dissolved in an organic solvent or ionic liquid with a sodium salt concentration higher than 2.0 M, or a combination thereof.

22. The rechargeable sodium cell of claim 1, which is a sodium-ion cell wherein the anode has an anode active material other than or in addition to sodium or sodium alloy, wherein the anode active material is selected from meso-phase pitch, meso-phase carbon, meso carbon micro-beads (MCMB), coke particles (e.g., needle coke), expanded graphite flakes, artificial graphite particles, natural graphite particles, highly oriented pyrolytic graphite, soft carbon particles, hard carbon particles, multi-walled carbon nanotubes, carbon nano-fibers, carbon fibers, graphite nano-fibers, graphite fibers, carbonized polymer fibers, carbon black, amorphous carbon, activated carbon, templated carbon, hollow carbon nanowires, hollow carbon sphere, silicon (Si), phosphorus (P), sodium titanates, NaTi₂(PO₄)₃, Na₂Ti₃O₇, Na₂C₈H₄O₄, Na₂TP, NaₓTiO₂ (x=0.2 to 1.0), disodium terephthalate (Na₂C₈H₄O₄), carboxylate based materials, C₈H₄Na₂O₄, C₈H₆O₄, C₈H₅NaO₄, C₈Na₂F₄O₄, C₁₀H₂Na₄O₈, C₁₄H₄O₆, C₁₄H₄Na₄O₈, or a combination thereof.

23. The rechargeable sodium cell of claim 1, which is a sodium-ion cell wherein the anode has an anode active material selected from the group consisting of (a) sodium- or potassium-doped silicon (Si), germanium (Ge), tin (Sn), lead (Pb), antimony (Sb), bismuth (Bi), zinc (Zn), aluminum (Al), titanium (Ti), cobalt (Co), nickel (Ni), manganese (Mn), cadmium (Cd), and mixtures thereof; (b) sodium- or potassium-containing alloys or intermetallic compounds of Si, Ge, Sn, Pb, Sb, Bi, Zn, Al, Ti, Co, Ni, Mn, Cd, and their mixtures; (c) sodium- or potassium-containing oxides, carbides, nitrides, sulfides, phosphides, selenides, tellurides, or antimonides of Si, Ge, Sn, Pb, Sb, Bi, Zn, Al, Fe, Ti, Co, Ni, Mn, Cd, and mixtures or composites thereof; (d) sodium or potassium salts; and (e) graphene sheets pre-loaded or pre-attached with sodium ions.

24. The rechargeable sodium cell of claim 1, which is a sodium-ion cell wherein the anode has an anode active material comprising a carbon or graphite material having an inter-planar spacing d₀₀₂ value from 0.43 nm to 3.0 nm wherein the carbon or graphite material is selected from meso-phase pitch, meso-phase carbon, meso carbon micro-beads (MCMB), coke particles, expanded graphite flakes, artificial graphite particles, natural graphite particles, highly oriented pyrolytic graphite, soft carbon particles, hard carbon particles, multi-walled carbon nanotubes, carbon nano-fibers, carbon fibers, graphite nano-fibers, graphite fibers, carbonized polymer fibers, or a combination thereof, wherein the carbon or graphite material, without a chemical or physical expansion treatment, has an inter-planar spacing d₀₀₂ from 0.27 nm to 0.42 nm prior and the inter-planar spacing d₀₀₂ is increased to a value from 0.43 nm to 3.0 nm after the expansion treatment.

25. The rechargeable sodium-ion cell of claim 24, wherein said carbon or graphite material is selected from graphite foam or graphene foam having pores and pore walls, wherein said pore walls contain a stack of bonded graphene planes having an expanded inter-planar spacing d₀₀₂ from 0.6 nm to 1.5 nm.

26. The rechargeable sodium cell of claim 24, wherein said expansion treatment includes a procedure selected from oxidation, fluorination, bromination, chlorination, nitrogenation, intercalation, combined oxidation-intercalation, combined fluorination-intercalation, combined bromination-intercalation, combined chlorination-intercalation, or combined nitrogenation-intercalation of said graphite or carbon material.

27. The rechargeable sodium-ion cell of claim 24, wherein said carbon or graphite material contains a non-carbon element selected from oxygen, fluorine, chlorine, bromine, iodine, nitrogen, hydrogen, or boron.

28. The rechargeable sodium cell of claim 21, wherein said working electrolyte contains a salt selected from an ionic liquid salt, sodium perchlorate (NaClO₄), potassium perchlorate (KClO₄), sodium hexafluorophosphate (NaPF₆), potassium hexafluorophosphate (KPF₆), sodium borofluoride (NaBF₄), potassium borofluoride (KBF₄), sodium hexafluoroarsenide, potassium hexafluoroarsenide, sodium trifluoro-metasulfonate (NaCF₃SO₃), potassium trifluoro-metasulfonate (KCF₃SO₃), bis-trifluoromethyl sulfonylimide sodium (NaN(CF₃SO2)₂), sodium trifluoromethanesulfonimide (NaTFSI), bis-trifluoromethyl sulfonylimide potassium (KN(CF₃SO₂)₂), a combination thereof, or a combination thereof with lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SOO₂)₂, Lithium bis(oxalato)borate (LiBOB), lithium oxalyldifluoroborate (LiBF₂C₂O₄), lithium oxalyldifluoroborate (LiBF₂C₂O₄), Lithium nitrate (LiNO₃), Li-Fluoroalkyl-Phosphates (LiPF₃(CF₂CF₃)₃), or lithium bisperfluoroethysulfonylimide (LiBETI).

29. The rechargeable sodium cell of claim 28, wherein said electrolyte comprises a solvent selected from ethylene carbonate (EC), dimethyl carbonate (DMC), methylethyl carbonate (MEC), diethyl carbonate (DEC), ethyl propionate, methyl propionate, propylene carbonate (PC), gamma.-butyrolactone (γ-BL), acetonitrile (AN), ethyl acetate (EA), propyl formate (PF), methyl formate (MF), toluene, xylene or methyl acetate (MA), fluoroethylene carbonate (FEC), vinylene carbonate (VC), allyl ethyl carbonate (AEC), 1,3-dioxolane (DOL), 1,2-dimethoxyethane (DME), tetraethylene glycol dimethylether (TEGDME), Poly(ethylene glycol) dimethyl ether (PEGDME), diethylene glycol dibutyl ether (DEGDBE), 2-ethoxyethyl ether (EEE), sulfone, sulfolane, a room temperature ionic liquid, or a combination thereof.

30. The rechargeable sodium cell of claim 1, wherein the cathode comprises a cathode active material selected from NaFePO₄, Na₍₁₋ₓ₎KₓPO₄, KFePO₄, Na_{0.7}FePO₄, Na_{1.5}VOPO₄F_{0.5}, Na₃V₂(PO₄)₃, Na₃V₂(PO₄)₂F₃, Na₂FePO₄F, NaFeF₃, NaVPO₄F, KVPO₄F, Na₃V₂(PO₄)₂F₃, Na_{1.5}VOPO₄F_{0.5}, Na₃V₂(PO₄)₃, NaV₆O₁₅, NaₓVO₂, Na_{0.33}V₂O₅, NaₓCoO₂, Na_{2/3}[Ni_{1/3}Mn_{2/3}]O₂, Naₓ(Fe_{1/2}Mn_{1/2})O₂, NaₓMnO₂, λ-MnO₂, NaₓK₍₁₋ₓ₎MnO₂, Na_{0.44}MnO₂, Na_{0.44}MnO₂/C, Na₄Mn₉O₁₈, NaFe₂Mn(PO₄)₃, Na₂Ti₃O₇, Ni_{1/3}Mn_{1/3}Co_{1/3}O₂, Cu_{0.56}Ni_{0.44}HCF, NiHCF, NaₓMnO₂, NaCrO₂, KCrO₂, Na₃Ti₂(PO₄)₃, NiCo₂O₄, Ni₃S₂/FeS₂, Sb₂O₄, Na₄Fe(CN)₆/C, NaV₁₋ₓCrₓPO₄F, Se_{z}S_{y}, y/z=0.01 to 100, Se, sodium polysulfide, sulfur, Alluaudites, or a combination thereof, wherein x is from 0.1 to 1.0.

31. The rechargeable sodium cell of claim 1, wherein the cathode comprises a cathode active material selected from a Na-based layered oxide, a polyanionic compound, a mixed polyanionic compound, a sulfate, a pyrophosphate, a Prussian Blue analog, or a combination thereof.

32. The rechargeable sodium cell of claim 1, wherein the cathode comprises a cathode active material selected from Na_{0.7}CoO₂, Na_{0.67}Ni_{0.25}Mg_{0.1}Mn_{0.65}O₂, Na_{0.5}[Ni_{0.23}Fe_{0.13}Mn_{0.63}]O₂, Na_{0.85}Li_{0.17}Ni_{0.21}Mn_{0.64}O₂, Zn doped Na_{0.833}[Li_{0.25}Mn_{0.75}]O₂, Na_{0.7}Mg_{0.05}[Mn_{0.6}Ni_{0.2}Mg_{0.15}]O₂, Na_{0.66}Co_{0.5}Mn_{0.5}O₂, Na_{2/3}Li_{1/9}Ni_{5/18}Mn_{2/3}O₂, C-coated NaCrO₂, Na_{0.9}[Cu_{0.22}Fe_{0.30}Mn_{0.48}]O₂, Na[Ni_{0.58}Co_{0.06}Mn_{0.36}]O₂, Na_{0.75}Ni_{0.82}Co_{0.12}Mn_{0.06}O₂, NaMn_{0.48}Ni_{0.2}Fe_{0.3}Mg_{0.02}O₂, V₂O₅ nanosheet, Na₃V₂(PO₄)₃, Na₃V₂(PO₄)₃/C, Na₃MnZr(PO₄)₃, Na₄Fe₃(PO₄)₂(P₂O₇), Na₃MnTi(PO₄)₃/C, carbon coated Na₃V₂(PO₄)₂F₃, Na₃(VOPO₄)₂F, graphene oxide protected Na₂₊₂ₓFe₂₋ₓ(SO₄)₃, Na_{2.3}Cu_{1.1}Mn₂O_{7-d}, graphene oxide protected Na₂FeP₂O₇, graphene oxide protected Na_{0.81}Fe[Fe(CN)₆]_{0.79-0.61}, Na₂CoFe(CN)₆, Ni_{0.67}Fe_{0.33}Se₂, or a combination thereof.

33. A process for manufacturing the rechargeable sodium cell of claim 1, the process comprising:
a) providing an anode comprising an anode current collector or an anode active material layer supported on a primary surface of an anode current collector;
b) providing a cathode comprising a cathode active material layer supported on a primary surface of an anode current collector;
c) depositing an elastic polymer electrolyte separator on the anode current collector, the anode active material layer, or the cathode active material layer;
d) combining the anode, the elastic polymer electrolyte separator, and the cathode to form a cell wherein the elastic polymer electrolyte separator is disposed between the anode and the cathode; and
e) encasing the cell in a protective housing to form the rechargeable sodium cell.

34. The process of claim 33, wherein step (c) comprises (A) providing (i) a liquid polymer solution comprising a high-elasticity polymer dissolved in a liquid solvent or (ii) a liquid reactive mass as a precursor to a high-elasticity polymer; (B) dispensing and depositing a layer of the liquid solution or the liquid reactive mass onto a solid substrate surface, wherein the solid substrate is the anode current collector, the anode active material layer, or the cathode active material layer; and (C) removing the liquid solvent from the liquid polymer solution to precipitate out the high-elasticity polymer or polymerizing and/or curing the reactive mass to form the layer of high-elasticity polymer separator.

35. The process of claim 34, wherein the liquid polymer solution or the liquid reactive mass comprises a lithium salt and/or a lithium ion-conducting material dissolved or dispersed therein.

36. The process of claim 34, which is a roll-to-roll process wherein said step (B) comprises (1) continuously feeding a layer of the solid substrate from a feeder roller to a dispensing zone where the liquid polymer solution or the reactive mass is dispensed and deposited onto the solid substrate to form a continuous layer of the liquid polymer solution or the reactive mass; and (2) moving the layer of the liquid polymer solution or the reactive mass into a reacting zone where the liquid polymer solution or the reactive mass is subjected to solvent removal or exposed to heat, ultraviolet light, or high-energy radiation to polymerize and/or cure the reactive mass to form a continuous layer of elastic polymer supported on said solid substrate.

37. The process of claim 36, wherein the solid substrate comprises an anode current collector or an anode active material layer supported on an anode current collector and the process further comprises continuously feeding a cathode active material layer, supported on a cathode current collector, to cover and combine with the elastic polymer layer to form a multi-layer structure.

38. The process of claim 37, further comprising winding and collecting the multi-layer structure on a winding roller.

39. The process of claim 37, further comprising cutting and trimming said multi-layer structure to form multiple pieces of battery cells.
